(19) United States
(12) Patent Application Publication
(10) Pub. No.: US 2025/0371841 A1
(43) Pub. Date: Dec. 4, 2025

(54) SYSTEMS, METHODS, AND APPARATUSES FOR EVALUATING CONTENT

(71) Applicant: Comcast Cable Communications, LLC, Philadelphia, PA (US)

(72) Inventors: Danfeng Xie, Philadelphia, PA (US); Sima Taheri, Philadelphia, PA (US); Renxiang Li, Philadelphia, PA (US)

(21) Appl. No.: 18/680,004

(22) Filed: May 31, 2024

(51) Int. Cl. G06V 10/70; G06Q 30/0241; G10L 15/26

(52) U.S. Cl. CPC G06V 10/70; G06Q 30/0241; G10L 15/26

(57) ABSTRACT

Methods, systems, and apparatuses are provided for generating a description or summary of a content item. A content item comprising a plurality of video frames may be received. One or more of the plurality of video frames may be evaluated to determine the visual stability of that particular video frame. The visual stability of the one or more of the plurality of video frames may be determined by comparing a video frame of the plurality of video frames to one or more video frames adjacent to the respective video frame. One or more of the most visually stable video frames of the at least the portion of the plurality of video frames in the content item may be selected for one or more scenes or shot angles in the content item. The selected video frames may then be analyzed to generate a summary or description of the content item.

### BACKGROUND

Several challenges exist with regard to analyzing and generating summaries of content items using conventional, automated or machine-learning models. For example, to understand the semantic composition of the content item, techniques must be able to recognize objects and their relationships, and also to interpret actions, events, and their implications. In addition, existing techniques lack the ability to comprehend temporal relationships, such as the sequence of events that are occurring in the content item and how the relationships of objects within the content item change over time. These and other shortcomings are identified and addressed in the disclosure.

### SUMMARY

It is to be understood that both the following general description and the following detailed description are exemplary and explanatory only and are not restrictive. Methods, systems, and apparatuses for evaluating content are described.

Methods, systems, and apparatuses are provided for generating a description or summary of a content item. One or more video frames of a plurality of video frames within a content item may be selected. For example, the one or more video frames may be selected based on determining the visual stability of one or more of the plurality of video frames. The visual stability of the one or more of the plurality of video frames may be determined by comparing a video frame of the plurality of video frames in the content item to one or more adjacent video frames (e.g., positioned before, positioned after, or positioned before and after) the respective video frame. One or more of the most visually stable video frames of the one or more of the plurality of video frames in the content item may be selected for each or a portion of one or more scenes or shot angles in the content item. The selected video frames may be evaluated to generate a textual description or summary of the content item.

This description or summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 shows an example system;

FIG. 3 shows a flowchart for an example method;

FIG. 4 shows an example system;

FIG. 5 shows a flowchart for an example method;

FIG. 6 shows a flowchart for an example method;

FIG. 7 shows a flowchart for an example method;

FIG. 8 shows a flowchart for an example method;

FIG. 9 shows a flowchart for an example method;

FIG. 10 shows a flowchart for an example method;

FIG. 11 shows a flowchart for an example method; and

FIG. 12 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of”' and is not intended to convey an indication of a preferred or ideal configuration. “Such as” is not used in a restrictive sense, but for explanatory purposes.

“Content data,” as the phrase is used herein, may also be referred to as “content,” “content items,” “content information,” “content asset,” “multimedia asset data file,” or simply “data” or “information”. Content data may be any information or data that may be licensed to one or more individuals (or other entities, such as business or group). Content data may be electronic representations of video, audio, text and/or graphics, which may be but is not limited to electronic representations of videos, movies, or other multimedia. The content data described herein may be electronic representations of music, spoken words, or other audio. In some cases, content data may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content data may be any combination of the above-described formats.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

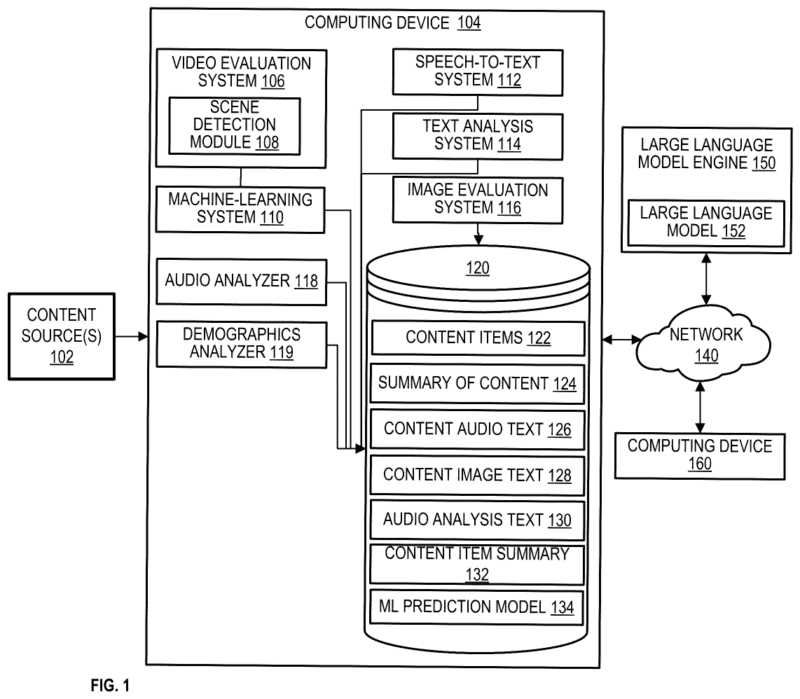

FIG. 1 shows an example system 100 for generating summaries of content items. The system 100 may comprise a content delivery network, a data network, a content distribution network, or any other network or content distribution system that one skilled in the art would appreciate. The system 100 may comprise one or more content sources 102, computing device 104, large language model 150, and computing device 160. FIG. 1 shows the computing device 104 as comprising a plurality of modules and components and the large language model engine 150 as comprising one module or component, for example only. It is to be understood that each of the content source 102, computing device 104, computing device 160, and the large language model engine 150 shown in the system 100 may comprise fewer or additional components/modules, other than those that are shown in FIG. 1. For example, while not shown in FIG. 1, the computing device 104 may comprise a content server and/or the large language model engine 150. In other example configurations of the system 100, any one or more of the video evaluation system 106, audio analyzer system 118, demographics analyzer system 119, speech-to-text system 112, text analysis system 114, image evaluation system 116, or machine learning system 110 may be a component/module of another computing device—or an entirely separate computing device (not shown). Other example configurations are possible.

The content sources 102, computing devices, 104, large language model engine 150, and/or the computing device 160 may communicate via a network 140. The network 140 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 140 via a variety of transmission paths along the data, power, communication, and/or content data transmission system, including wireless paths (e.g., satellite paths, Wi-Fi paths, cellular paths, etc.) and terrestrial paths (e.g., wired paths (e.g., coaxial cable or fiber-optic), a direct feed source via a direct line, etc.).

The system 100 may comprise one or more content sources 102. Each of the one or more content sources 102 may be configured to provide content (e.g., content items such as video, audio, games, applications, data) to the computing device 104 via the network 140 or another network. The content sources 102 may be configured to provide live content, streaming content, on-demand content (e.g., video on-demand), content recordings, and/or the like. The content sources 102 may be managed by one or more third party content providers, service providers, online content providers, over-the-top content providers, and/or the like. The content may be provided via broadcast, a subscription, by individual item purchase or rental, and/or the like. For example, the content sources 102 may be configured to provide the content via a QAM network or via a packet switched network path, such as via an internet protocol (IP) based connection. The content may be accessed by user devices (e.g., the computing device 160) via applications or device, such as mobile applications, televisions, television applications, set-top boxes, set-top box applications, gaming devices, gaming device applications, and/or the like. An application may be a custom application (e.g., by content provider, for a specific device), a general content browser (e.g., web browser), an electronic program guide, and/or the like.

The content sources 102 may provide a variety of content items. For example, each content item may comprise audio content and video content. For example, each content item may further comprises one or more of closed-captioning data, text data, or metadata. For example, each content item may comprise one or more video frames of video content and one or more audio frames of audio content. The content sources 102 may encode the audio frames and the video frames. The content sources 102 may encode metadata into the audio frames and the video frames.

The computing device 104 may comprise a server (e.g., a content server) and/or a device (e.g., an encoder, decoder, transcoder, packager, etc.). The computing device 104 may generate and/or output portions of content (e.g., content items) for consumption (e.g., output). For example, the computing device 104 may convert raw versions of content items into compressed or otherwise more “consumable” versions suitable for playback/output by user devices, media devices, and other consumer-level computing devices (e.g., the computing device 160). For ease of explanation, the description herein may refer to the computing device 104 in the singular form. However, it is to be understood that the computing device 104 may comprise a plurality of servers and/or a plurality of devices that operate as a system to determine and generate summaries of received content items, to generate and/or output content items, and/or convert raw versions of content into compressed or otherwise more “consumable” versions, etc.

The computing device 104 may comprise a transcoder, a segment packetizer, a manifest generator, a video evaluation system 106, a machine learning system 110, a speech-to-text system 112, a text analysis system 114, an image evaluation system 116, an audio analyzer system 118, and/or a demographics analyzer system 119, each of which may correspond to hardware, software (e.g., instructions executable by one or more processors of the computing device 104), or a combination thereof. The transcoder may perform bitrate conversion, coder/decoder (CODEC) conversion, frame size conversion, etc. for each content item. For example, the computing device 104 may receive source content from one or more content sources 102 (e.g., one or more content items, such as movies, television shows, sporting events, news shows, advertisements, offers for goods and/or services, etc.) and the transcoder may transcode the source content to generate one or more transcoded content. The computing device 104 may receive the source content from an external source (e.g., a stream capture source, a data storage device, a media server, etc.). The computing device 104 may receive the source content via a wired or wireless network connection, such as the network 140 or another network (not shown). It should be noted that although a single source 102 of content is shown in FIG. 1, this is not to be considered limiting. The computing device 104 may receive content items from any number of content sources 102.

The computing device 104 may instruct the transcoder to generate the one or more transcoded content 121 for one or more content items. The computing device 104 may cause the transcoded content, as well as associated metadata that identifies each portion of the corresponding content items, to be stored by the segment packetizer in a storage medium 120, as shown in FIG. 1. While FIG. 1 shows the storage medium 120 as being a part of the computing device 104, it is to be understood that the storage medium 120 may be a separate entity or entities. The storage medium 120 may store the transcoded content of the content items (e.g., recorded content items 122).

The storage media 120 (e.g., one or more databases) may store portions of content items 122, such as segments, fragments, video/audio files, a combination thereof, and/or the like. For example, the computing device 104 may store or cause each portion of the corresponding content items 122 and/or the metadata that identifies each portion of the corresponding content items to be stored in the storage medium 120.

The video evaluation system 106 may receive the video content of a received content item from the content source 102 or from the content items 122 portion of the storage media 120. The video evaluation system 106 may comprise a scene detection module 108. The scene detection module 108 may be configured to determine the one or more scenes or shot angles in the content item. For example, the scene detection module 108 may determine that the video content of the content item comprises a plurality of scenes or shot angle within the content item. The scene detection module 108 may determine the start point and the end point of each scene or shot angle for the content item. For example, the scene detection module 108 may determine and record the video frame number and/or runtime clock value of the beginning video frame and ending video frame of each scene or shot angle of the content item. For example, the scene detection module 108 may store or associate the start and end points of each scene or shot angle of the content item with the particular content item (e.g., within metadata associated with the particular content item) in the content items 122 portion of the storage media 120.

The video evaluation system 106 may determine a portion of the video frames of the video content of the content item to select. For example, the video evaluation system 106 may select one or more than one video frame of the content item in each scene or shot angle of the content item. For example, the video evaluation system 106 may determine one or more of a stability level, motion factor, or quantity of changes for each video frame of the plurality of video frames in the video content of the content item by comparing a video frame to one or more of the immediately preceding video frame or the immediately following video frame to determine an amount of motion or number of changes (e.g., pixel changes) that have occurred when transitioning from the immediately preceding video frame to the video frame and/or when transitioning from the video frame to the immediately following video frame. For example, the video evaluation system 106 may select the video frame or frames that have one or more of the highest stability level, lowest motion factor (e.g., no visual items in the video frame moving when transitioning between video frames), or fewest quantity of changes (e.g., pixel changes) when transitioning between video frames of the video content.

The video evaluation system 106 may then provide or input the selected portion of the plurality of video frames of the video content (e.g., one video frame for each scene or shot angle in the video content of the content item) to a machine-learning prediction model 134 provided by the machine-learning system 110 to determine an initial description or summary of the content in the content item. For example, only the selected portion of the plurality of video frames of the video content and the machine learning prediction module 134 may be used to determine the initial description or summary for the content of the content item. The initial description or summary may be a text-based description of the content in the content item. The determined or generated initial description or summary for the content of the content item may be stored in the summary of content 124 portion of the storage media 120. In certain examples, an initial description or summary may be generated for all or a portion of the content items received by the computing device 104.

The speech-to-text system 112 may receive at least the audio content of the content item. The speech-to-text system 112 may evaluate the audio content of the content item to determine the spoken words in the audio content of the content item. The speech-to-text system 112, based on the determined spoken words in the audio content, may determine or generate a textual representation of the plurality of spoken words in the audio content of the content item. The textual representation of the plurality of spoken words in the audio content may represent or include all or a portion of the spoken words in the audio content. The textual representation may be in run-time order for the audio content of the content item. For example, the speech-to-text system 112 may be configured to convert the spoken words in the audio content into text for the textual representation of the plurality of spoken words in the audio content. The speech-to-text system 112 may store the textual representation of the plurality of spoken words in the audio content in the content audio text 126 portion of the storage media 120.

The text analysis system 114 may receive text data (e.g., closed captioning text data) associated with the audio content of the content item. The text analysis system 114 may parse the text data to determine the spoken words in the audio content of the content item. The text analysis system 114 may, based on the determined spoken words, determine or generate a textual representation of the plurality of spoken words in the audio content. The textual representation of the plurality of spoken words in the audio content may represent or include all or a portion of the spoken words in the audio content. The text analysis system 114 may store the textual representation of the plurality of spoken words in the audio content in the content audio text 126 portion of the storage media 120.

The image evaluation system 116 may receive at least the video content of the content item. The image evaluation system 116 may scan or evaluate the video content to determine or identify one or more words visually presented in the video content of the content item. For example, the image evaluation system 116 may evaluate the video content of the content item using optical character recognition or another form of text identifier to identify and/or determine the one or more words visually presented (e.g., “stop” of a stop sign, a product name, a phone number, etc.) in the video content. For example, the image evaluation system 116 may evaluate all or a portion of the video content and determine all or a portion of the words visually presented in the video content of the content item. The image evaluation system 116 may, based on the determined words visually presented in the video content, determine or generate a textual representation of the one or more words visually presented in the video content of the content item. For example, the textual representation of the one or more words visually presented in the video content may comprise a text-based listing or readout of the one or more words in run-time order of the video content of the content item. The image evaluation system 116 may store the textual representation of the one or more words visually presented in the video content for the content item in the content image text 128 portion of the storage media 120.

The audio analyzer system 118 may receive at least the audio content of the content item. The audio analyzer system 118 may evaluate the non-verbal audio (e.g., any music, background noise, and/or sound effects) included in the audio content of the content item to determine and/or generate a textual representation (e.g., a text description) of the non-verbal audio (e.g., spooky music, loud explosion, ticking clock) in the audio content of the content item. For example, the audio analyzer system 118 may determine or generate the textual representation, based on the audio content of the content item. For example, the audio analyzer system 118 may determine or generate the textual representation of the non-verbal audio in run-time order of the audio content for the content item. The audio analyzer system 118 may store the textual representation of the non-verbal audio in the audio content of the content item in the audio analysis text 130 portion of the storage media 120.

The demographics analyzer 119 may evaluate the initial description or summary of the content in the content item and/or the second description or summary generated by the large language model 152 (as discussed below) and determine one or more user demographics to associate with the initial description or summary or second description or summary. For example, if the content item is an advertisement for medication for post-menopausal women, then at least the demographics of sex (e.g., female) and age (over 45 years of age) may be associated with the content item. The demographics analyzer 119 may store the demographics determined to be associated with the content item along with the content items or within the metadata for the particular content item in the content items 122 portion of the storage media 120.

The large language model engine 150 may comprise a large language model 152. The large language model engine 150 may be configured to receive text-based data and, based on the received text-based data and using the large language model 152, determine and/or generate a second description or summary (as distinguished from the initial description or summary determined or generated by the video evaluation system 106) of the content in the content item. For example, the second description or summary may be determine or generated based on the initial description or summary of the content in the content item, the textual representation of the spoken words in the audio content (or text data) of the content item, the textual representation of the one or more words visually presented in the video content of the content item, and/or the textual representation of the non-verbal audio in the audio content of the content item. For example, the large language model engine 150 may receive the initial description or summary of the content in the content item, the textual representation of the spoken words in the audio content (or text data) of the content item, the textual representation of the one or more words visually presented in the video content of the content item, and/or the textual representation of the non-verbal audio in the audio content of the content item from the computing device 104 via the network 140 or another network. In examples where the large language model engine 150 is part of the computing device 104, the data may be sent via an internal transmission without need for the network 140. The large language model engine 150, using the large language model 152, may, based on receiving the initial description or summary of the content in the content item, the textual representation of the spoken words in the audio content (or text data) of the content item, the textual representation of the one or more words visually presented in the video content of the content item, and/or the textual representation of the non-verbal audio in the audio content of the content item, determine or generate the second description or summary of the content of the content item. The large language model engine 150 may send the second description or summary of the content of the content item to the computing device 104 via the network 140 or another network. For example, the second description or summary of the content may be stored in the content item summary 132 of the storage media 120.

The computing device 160 may communicate with the computing device 104 via the network 140 or another network. The computing device 160 may comprise a user device, such as a laptop computer, a desktop computer, a computing station, a tablet device, a mobile computing device, a mobile phone, a peer device, or a wearable smart device, a server, a network computer, an edge device, or other common network nodes, etc. The computing device 160 may be associated with a user, such as the person owning or currently using the computing device 160. The computing device 160 may send requests for content items to the computing device 104 via the network 140 or another network and receive the requested content item from the computing device 104 (or another computing device) via the network 140 or another network. The user associated with the computing device 160 may represent, be part of or be associated with one or more user demographics.

For example, when the computing device 160 sends a request for a second content item to the computing device 104, the computing device 104 may determine an identifier of the user device (e.g., device ID, MAC address) and/or the user (e.g., user name, user number, user ID) associated with the user device. For example, the identifier of the user device and/or user may be included in the request for the second content item. Based on the identifier of the user device and/or the user, one or more demographics of the user associated with the user device may be determined by the computing device (e.g., the demographics analyzer 119). For example, the one or more demographics may be stored in the storage media 120 as user data and associated with the particular user. For example, the one or more demographics of the user may be provided by the user via the computing device 160 or may be determined using other methods, such as based on history of content items viewed by user, purchase history, or demographic information associated with the user location. The computing device 104 may determine that one or more of the one or more demographics of the user may match one or more of the user demographics associated with a content item for which an initial description or summary and/or second description or summary were generated. Based on the match of one or more of the user demographics, the computing device 104 (or another computing device) may send or otherwise cause transmission of the content item to the computing device 160 associated with the user and cause the content item to be displayed on the computing device 160 associated with the user before or as part of sending the requested second content item to the computing device 160.

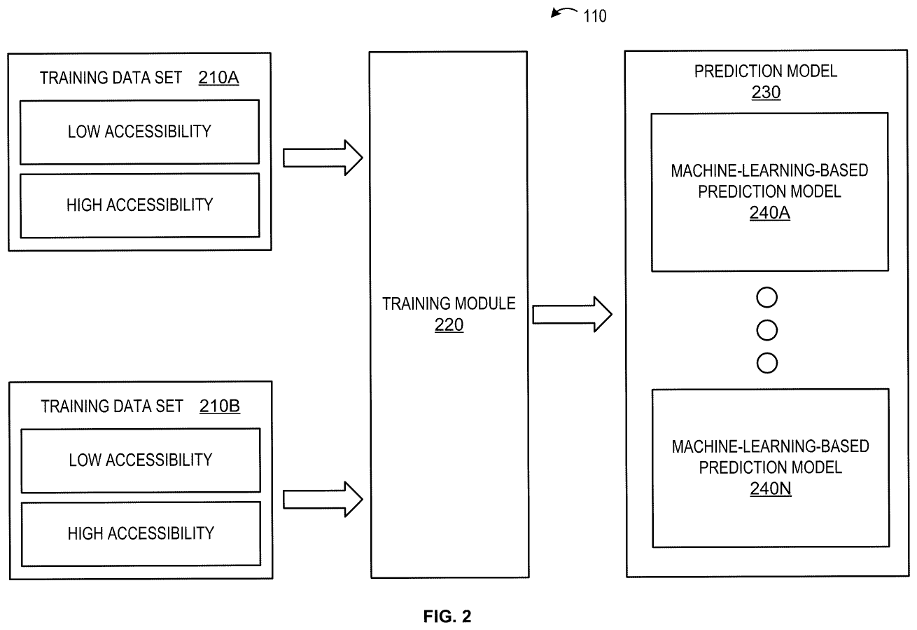

Machine-learning and other artificial intelligence techniques may be used to train a prediction model. The prediction model, once trained, may be configured to determine or generate a description or summary of content within a content item based on one or more video frames of the video content of the content item. For example, the computing device 104 of the system 100 may use the trained prediction model 134 to determine or generate a description or summary of a received content item based on an evaluation of a plurality of video frames of the video content of the content item. The prediction model (referred to herein as the at least one prediction model 230, 134, or simply the prediction model 230, 134) may be trained by a system 110 as shown in FIG. 2. The system 110 may be part of the computing device 104 or a one or more other separate computing devices configured to provide the prediction model 230, 134 to the computing device 104, via the network 140 or another network, for analysis of the plurality of video frames of video content of the content item.

The system 110 may be configured to use machine-learning techniques to train, based on an analysis of one or more training datasets 210A-210B by a training module 220, the at least one prediction model 230, 134. The at least one prediction model 230, 134, once trained, may be configured to determine or generate a description or summary of a received content item based on an evaluation of a plurality of video frames of the video content of the content item. A dataset may be determined or derived from a plurality of content items 122. For example, previous or historical content items and selected video frames from those content items may be used by the training module 220 to train the at least one prediction model 230, 134. Each of the video frames of a content item and associated description or summary derived based on that video frame or plurality of video frames may be associated with one or more multimodal features of a plurality of multimodal features that are associated with the determination of a description or summary (e.g., an initial description or summary) of the content item. The plurality of multimodal features and example summaries of the content items may be used to train the at least one prediction model 230, 134.

The training dataset 210A may comprise a first portion of the previous or historical content items in the dataset. Each previous or historical content item may have an associated plurality of video frames used for generating a description or summary of the content item, the description or summary of the content item and one or more labeled multimodal features associated with the plurality of video frames and generated description or summary for the content item. The training dataset 210B may comprise a second portion of the previous or historical content items in the dataset. Each previous or historical content item may have an associated plurality of video frames used for generating a description or summary of the content item, the description or summary of the content item, and one or more labeled multimodal features associated with the plurality of video frames and generated description or summary for the content item. The previous or historical content items and associated video frames and description or summary may be randomly assigned to the training dataset 210A, the training dataset 210B, and/or to a testing dataset. In some implementations, the assignment of previous or historical content items and associated video frames and description or summary to a training dataset or a testing dataset may not be completely random. In this case, one or more criteria may be used during the assignment, such as ensuring that similar numbers of previous or historical content items with different numbers of scenes and/or video frames used to derive the description or summary and/or multimodal features are in each of the training and testing datasets. In general, any suitable method may be used to assign the previous or historical content items and associated video frames and generated description or summary to the training or testing datasets, while ensuring that the distributions of number of video frames used to generate the description or summary from the content item and/or multimodal features are somewhat similar in the training dataset and the testing dataset.

The training module 220 may use the first portion and the second portion of the previous or historical content items and associated video frames of those content items to determine one or more multimodal features that are indicative of an accurate (e.g., a high confidence level for the) description or summary of the content item. That is, the training module 220 may determine which multimodal features associated with the visual information provided by the video frames of each respective video content of the respective content item are correlative with an accurate description or summary of the content item. The one or more multimodal features indicative of an accurate description or summary of the content item may be used by the training module 220 to train the prediction model 230, 134. For example, the training module 220 may train the prediction model 230 by extracting a feature set (e.g., one or more multimodal features) from the first portion in the training dataset 210A according to one or more feature selection techniques. The training module 220 may further define the feature set obtained from the training dataset 210A by applying one or more feature selection techniques to the second portion in the training dataset 210B that includes statistically significant features of positive examples (e.g., accurate description or summary of a content item based on the plurality of video frames of the video content) and statistically significant features of negative examples (e.g., inaccurate description or summary of the content item based on the plurality of video frames of the video content). The training module 220 may train the prediction model 230 by extracting a feature set from the training dataset 210B that includes statistically significant features of positive examples (e.g., accurate description or summary of a content item based on the plurality of video frames of the video content) and statistically significant features of negative examples (e.g., inaccurate description or summary of a content item based on the plurality of video frames of the video content).

The training module 220 may extract a feature set from the training dataset 210A and/or the training dataset 210B in a variety of ways. For example, the training module 220 may extract a feature set from the training dataset 210A and/or the training dataset 210B using a multimodal detector. The training module 220 may perform feature extraction multiple times, each time using a different feature-extraction technique. In one example, the feature sets generated using the different techniques may each be used to generate different machine-learning-based prediction models 240. For example, the feature set with the highest quality metrics may be selected for use in training. The training module 220 may use the feature set(s) to build one or more machine-learning-based prediction models 240A-240N that are configured to provide a description or summary of a content item based on the plurality of video frames of the video content for a previous or historical content item.

The training dataset 210A and/or the training dataset 210B may be analyzed to determine any dependencies, associations, and/or correlations between multimodal features and the predetermined summaries in the training dataset 210A and/or the training dataset 210B. The identified correlations may have the form of a list of multimodal features that are associated with different summaries of content items. The multimodal features may be considered as features (or variables) in the machine-learning context. The term “feature,” as used herein, may refer to any characteristic of an item of data that may be used to determine whether the item of data falls within one or more specific categories or within a range. By way of example, the features described herein may comprise one or more multimodal features.

A feature selection technique may comprise one or more feature selection rules. The one or more feature selection rules may comprise a multimodal feature occurrence rule. The multimodal feature occurrence rule may comprise determining which multimodal features in the training dataset 210A occur over a threshold number of times and identifying those multimodal features that satisfy the threshold as candidate features. For example, any multimodal features that appear greater than or equal to 5 times in the training dataset 210A may be considered as candidate features. Any multimodal features appearing less than 5 times may be excluded from consideration as a feature. Other threshold numbers may be used in the place of the example 5 times presented above.

A single feature selection rule may be applied to select features or multiple feature selection rules may be applied to select features. The feature selection rules may be applied in a cascading fashion, with the feature selection rules being applied in a specific order and applied to the results of the previous rule. For example, the multimodal feature occurrence rule may be applied to the training dataset 210A to generate a first list of multimodal features. A final list of candidate multimodal features may be analyzed according to additional feature selection techniques to determine one or more candidate multimodal feature groups (e.g., groups of multimodal features that may be used to predict a description or summary of a content item based on the plurality of video frames of the video content of the content item). Any suitable computational technique may be used to identify the candidate multimodal feature groups using any feature selection technique such as filter, wrapper, and/or embedded methods. One or more candidate multimodal feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine-learning algorithms used by the system 110. Instead, features may be selected on the basis of scores in various statistical tests for their correlation with the outcome variable (e.g., a predicted viewing window).

As another example, one or more candidate multimodal feature groups may be selected according to a wrapper method. A wrapper method may be configured to use a subset of features and train the prediction model 230, 134 using the subset of features. Based on the inferences that are drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate multimodal feature groups. Forward feature selection is an iterative method that begins with no features. In each iteration, the feature which best improves the model is added until an addition of a new variable does not improve the performance of the model. As another example, backward elimination may be used to identify one or more candidate multimodal feature groups. Backward elimination is an iterative method that begins with all features in the model. In each iteration, the least significant feature is removed until no improvement is observed on removal of features. Recursive feature elimination may be used to identify one or more candidate multimodal feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate multimodal feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 220 has generated a feature set(s), the training module 220 may generate the one or more machine-learning-based prediction models 240A-240N based on the feature set(s). A machine-learning-based prediction model (e.g., any of the one or more machine-learning-based prediction models 240A-240N) may refer to a complex mathematical model for data classification that is generated using machine-learning techniques as described herein. In one example, a machine-learning-based prediction model may include a map of support vectors that represent boundary features. By way of example, boundary features may be selected from, and/or represent the highest-ranked features in, a feature set.

The training module 220 may use the feature sets extracted from the training dataset 210A and/or the training dataset 210B to build the one or more machine-learning-based prediction models 240A-240N for each classification category (e.g., description or summary or summary type of a content item based on the plurality of video frames of the video content of the content item). In some examples, the one or more machine-learning-based prediction models 240A-240N may be combined into a single machine-learning-based prediction model 240 (e.g., an ensemble model). Similarly, the prediction model 230, 134 may represent a single classifier containing a single or a plurality of machine-learning-based prediction models 240 and/or multiple classifiers containing a single or a plurality of machine-learning-based prediction models 240 (e.g., an ensemble classifier).

The extracted features (e.g., one or more candidate multimodal features) may be combined in the one or more machine-learning-based prediction models 240A-240N that are trained using a machine-learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting prediction model 230, 134 may comprise a decision rule or a mapping for each candidate multimodal feature in order to generate or determine a predicted description or summary of a content item based on the plurality of video frames of the video content of the content item). As described further herein, the resulting prediction model 230, 134 may be used to generate or determine a description or summary of a content item based on the plurality of video frames of the video content of the content item. The candidate multimodal features and the prediction model 430 may be used to predict a description or summary of a content item based on the plurality of video frames of the video content of the content item.

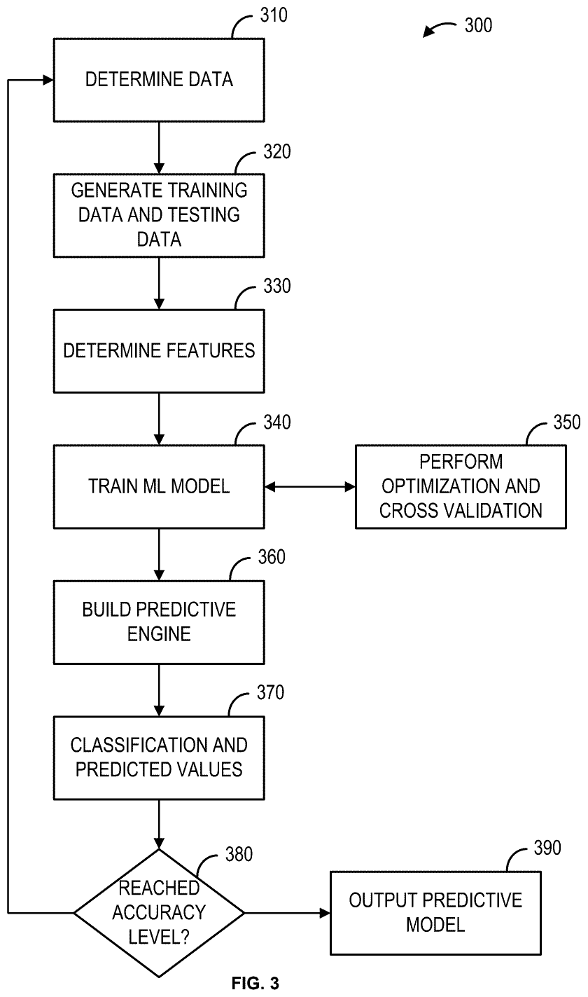

FIG. 3 is a flowchart illustrating an example training method 300 for generating the prediction model 230, 134 using the training module 220. The training module 220 can implement supervised, unsupervised, and/or semi-supervised (e.g., reinforcement based) machine-learning-based prediction models 240A-240N. The method 300 illustrated in FIG. 3 is an example of a supervised learning method; variations of this example of training method are discussed below, however, other training methods can be analogously implemented to train unsupervised and/or semi-supervised machine-learning models. The method 300 may be implemented by the computing devices 104, 110, 150 or by another computing device, such as a separate machine-learning computing system.

At 310, the training method 300 may determine (e.g., access, receive, retrieve, etc.) first previous or historical content items, selected video frames from the content items, and associated description or summary of the content item (e.g., the first portion of the previous or historical content items described above) and second previous or historical content items, selected video frames from the content items, and associated description or summary of the content item (e.g., the second portion of the previous or historical content items described above). The first previous or historical content items and the second previous or historical content items may each comprise one or more multimodal features and a predetermined description or summary of the content item based on the selected plurality of video frames for that content item. The training method 300 may generate, at 320, a training dataset and a testing dataset. The training dataset and the testing dataset may be generated by randomly assigning previous or historical content items and associated selected video frames and description or summary from the first previous or historical content items and/or the second previous or historical content items to either the training dataset or the testing dataset. In some implementations, the assignment of previous or historical content items and associated selected video frames and predetermined description or summary as training or test samples may not be completely random. As an example, only the previous or historical content item and associated selected video frames and description or summary for a specific multimodal feature(s) and/or type(s) of summaries may be used to generate the training dataset and the testing dataset. As another example, a majority of the previous or historical content items and associated selected video frames and description or summary for the specific multimodal feature(s) and/or type(s) of summaries may be used to generate the training dataset. For example, 75% of the previous or historical content items and associated selected video frames and description or summary for the specific multimodal feature(s) and/or type(s) of summaries may be used to generate the training dataset and 25% may be used to generate the testing dataset.

The training method 300 may determine (e.g., extract, select, etc.), at 330, one or more features that can be used by, for example, a classifier to differentiate among different classifications (e.g., summaries or summary types). The one or more features may comprise a set of multimodal features. As an example, the training method 300 may determine a set features from the first previous or historical content items and associated selected video frames and description or summary. As another example, the training method 300 may determine a set of features from the second previous or historical content items and associated selected video frames and description or summary. In a further example, a set of features may be determined from other previous or historical content items and associated selected video frames and description or summary of the plurality of previous or historical content items and associated selected video frames and description or summary (e.g., a third portion) associated with a specific multimodal feature(s) and/or type(s) of summaries associated with the previous or historical content items and associated selected video frames and description or summary of the training dataset and the testing dataset. In other words, the other previous or historical content items and associated selected video frames and description or summary (e.g., the third portion) may be used for feature determination/selection, rather than for training. The training dataset may be used in conjunction with the other previous or historical content items and associated selected video frames and description or summary to determine the one or more features. The other previous or historical content items and associated selected video frames and description or summary may be used to determine an initial set of features, which may be further reduced using the training dataset.

The training method 300 may train one or more machine-learning models (e.g., one or more prediction models) using the one or more features at 340. In one example, the machine-learning models may be trained using supervised learning. In another example, other machine-learning techniques may be employed, including unsupervised learning and semi-supervised. The machine-learning models trained at 340 may be selected based on different criteria depending on the problem to be solved and/or data available in the training dataset. For example, machine-learning models can suffer from different degrees of bias. Accordingly, more than one machine-learning model can be trained at 340, and then optimized, improved, and cross-validated at 350.

The training method 300 may select one or more machine-learning models to build the prediction model 230, 134 at 360. The prediction model 230, 134 may be evaluated using the testing dataset. The prediction model 230, 134 may analyze the testing dataset and generate classification values and/or predicted values (e.g., a predicted description or summary of the content item provided in the testing dataset) at 370. Classification and/or prediction values may be evaluated at 380 to determine whether such values have achieved a desired accuracy level (e.g., a confidence level for the predicted description or summary of the content item). Performance of the prediction model 230, 134 may be evaluated in a number of ways based on a number of true positives, false positives, true negatives, and/or false negatives classifications of the plurality of data points indicated by the prediction model 230, 134.

For example, the false positives of the prediction model 230, 134 may refer to a number of times the prediction model 230 incorrectly assigned an accurate description or summary to a previous or historical content item based on the selected video frames of the content item with a low confidence level. Conversely, the false negatives of the prediction model 230 may refer to a number of times the machine-learning model assigned an inaccurate description or summary to a previous or historical content item based on the selected video frames of the content item associated with a high confidence level. True negatives and true positives may refer to a number of times the prediction model 330 correctly assigned a description or summary to a previous or historical content item based on the selected video frames of the content item based on the known, predetermined description or summary for the particular content item and selected video frames. Related to these measurements are the concepts of recall and precision. Generally, recall refers to a ratio of true positives to a sum of true positives and false negatives, which quantifies a sensitivity of the prediction model 230, 134. Similarly, precision refers to a ratio of true positives, a sum of true and false positives. When such a desired accuracy level (e.g., confidence level) is reached, the training phase ends and the prediction model 230, 134 may be output at 390; when the desired accuracy level is not reached, however, then a subsequent iteration of the training method 300 may be performed starting at 310 with variations such as, for example, considering a larger collection of previous or historical content items and associated selected video frames and description or summary.

The prediction model 230, 134 may be output at 390. The prediction model 230, 134 may be configured to provide a predicted description or summary to a previous or historical content item based on the selected video frames of the content item for content items that are not within the plurality of previous or historical content items used to train the prediction model. For example, the prediction model 230, 134 may be trained and output by a first computing device. The first computing device may provide the prediction model 230, 134 to a second computing device, such as the computing device 104. As described herein, the method 300 may be implemented by the computing device 104 or another computing device.

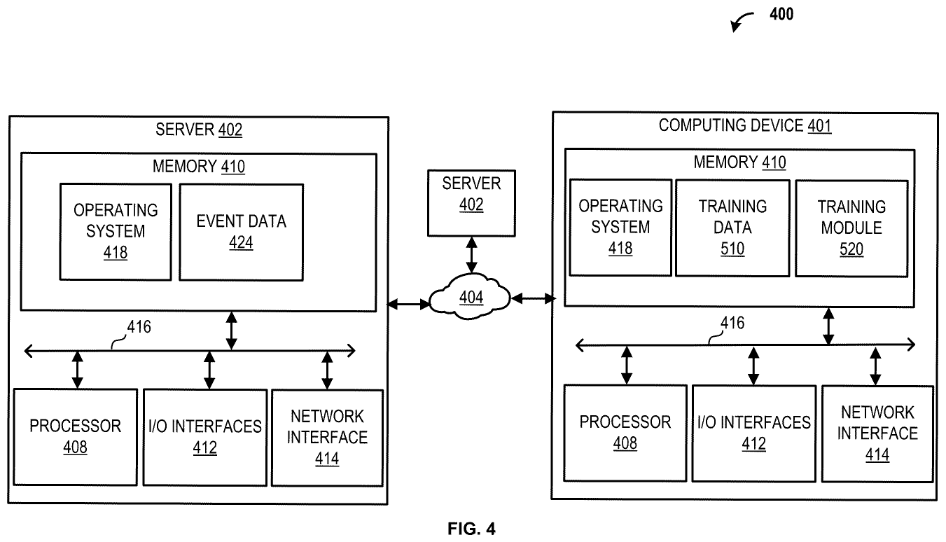

As discussed herein, the present methods and systems may be computer-implemented. FIG. 4 shows a block diagram depicting an environment 400 comprising non-limiting examples of a computing device 401 and a server 402 connected through a network 404, such as the network 140. The computing device 401 and/or the server 402 may be any one of the computing devices 104, the machine-learning system 110, or the large language model engine 150 of FIG. 1. In an aspect, some or all steps of any described method herein may be performed on a computing device as described herein. The computing device 401 can comprise one or multiple computers configured to store one or more of the training module 420, training data 410, and the like. The server 402 can comprise one or multiple computers configured to store, send, and/or transmit power, data, communications, and/or content data (e.g., a plurality of content items). Multiple servers 402 can communicate with the computing device 401 via the through the network 404.

The computing device 401 and the server 402 may each be a digital computer that, in terms of hardware architecture, generally includes a one or more processors 408, memory system 410, input/output (I/O) interfaces 412, and network interfaces 414. These components (408, 410, 412, and 414) are communicatively coupled via a local interface 416. The local interface 416 can be, for example, but not limited to, one or more buses or other wired or wireless connections, as is known in the art. The local interface 416 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The one or more processors 408 can be hardware device(s) for executing software, particularly that stored in memory system 410. The one or more processors 408 can be any custom made or commercially available processor, a central processing unit (CPU), an auxiliary processor among several processors associated with the computing device 401 and the server 402, a semiconductor-based microprocessor (in the form of a microchip or chip set), or generally any device for executing software instructions. When the computing device 401 and/or the server 402 is in operation, the one or more processors 408 can be configured to execute software stored within the memory system 410, to communicate data to and from the memory system 410, and to generally control operations of the computing device 401 and the server 402 pursuant to the software.

The I/O interfaces 412 can be used to receive user input from, and/or for providing system output to, one or more devices or components. User input can be provided via, for example, a keyboard and/or a mouse. System output can be provided via a display device and a printer (not shown). I/O interfaces 412 can include, for example, a serial port, a parallel port, a Small Computer System Interface (SCSI), an infrared (IR) interface, a radio frequency (RF) interface, and/or a universal serial bus (USB) interface.

The network interface 414 can be used to transmit and receive from the computing device 401 and/or the server 402 on the network 404. The network interface 414 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The memory system 410 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 610 may incorporate electronic, magnetic, optical, and/or other types of storage media. Note that the memory system 410 can have a distributed architecture, where various components are situated remote from one another, but can be accessed by the one or more processors 408.

The software in memory system 410 may include one or more software programs, each of which comprises an ordered listing of executable instructions for implementing logical functions associated with the one or more methods described herein. In the example of FIG. 4, the software in the memory system 410 of the computing device 401 can comprise the training module 420 (or subcomponents thereof), the training data 410, and a suitable operating system (O/S) 418. In the example of FIG. 4, the software in the memory system 410 of the server 402 can comprise, the previous or historical content items and associated selected video frames and summaries 424, and a suitable operating system (O/S) 418. The operating system 418 essentially controls the execution of other computer programs and provides scheduling, input-output control, file and data management, memory management, and communication control and related services.

For purposes of illustration, application programs and other executable program components such as the operating system 418 are illustrated herein as discrete blocks, although it is recognized that such programs and components can reside at various times in different storage components of the computing device 401 and/or the server 402. An implementation of the training module 420 can be stored on or transmitted across some form of computer-readable media. Any of the disclosed methods can be performed by computer-readable instructions embodied on computer-readable media (e.g., non-transitory computer-readable media). Computer-readable media can be any available media that can be accessed by a computer. By way of example and not meant to be limiting, computer-readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

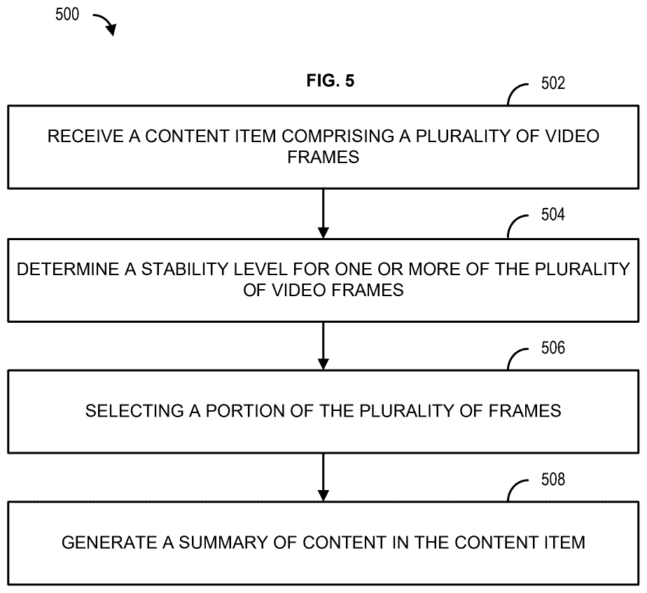

FIG. 5 shows a flowchart of an example method 500 for creating or generating a description or summary of a content item based on an analyses of one or more video frames of a plurality of video frames for the content item. The methods described in FIG. 5 may be completed by a computing device, such as the computing device 104, and/or the machine-learning system 110, or any other computing device described herein. While the method 500 of FIG. 5 will be described as being completed by the computing device 104, this is for example purposes only.

At 502, a content item may be received. For example, the content item may be received by the computing device 104 from one of the content sources 102. For example, the content item may be one or more of an advertisement, an offer for goods or services, a sporting event highlight or review, a news event highlight or review, a preview for or an actual movie, or a preview for or a television show. For example, the computing device 104 may receive the content item from one of the content sources via a network device, such as network device 140. For example, the content item may be received from the database 120, which previously received the content item from one of the content sources 102. For example, all or a portion of the content item may be received by the video evaluation system 106 of the computing device 104. For example, the content item may comprise video content and audio content. The video content may comprise a plurality of video frames.

For example, the video evaluation system 106 may receive the plurality of video frames of the content item. The scene detection module 108 of the video evaluation system 106, another portion of the computing device 104, or another computing device may determine one or more scenes or shot angles in the content item (e.g., in the video content of the content item). For example, the scene detection module 108 may determine that the content item comprises a plurality of scenes or shot angles. The scene detection module 108 may determine the beginning and ending point of each scene or shot angle in the content item (e.g., in the video content of the content item). The scene detection module 108 may record or store the beginning and ending point of each scene or shot angle identified. For example, the scene detection module may identify and record the video frame number and/or runtime clock value of the beginning video frame and ending video frame of each scene or shot angle.

At 504, the video evaluation system 106 or another portion of the computing device 104 may determine a stability level for a video frame of the plurality of video frames, one or more of the plurality of video frames, or a plurality of video frames of the video content of the content item. For example, the video evaluation system 106 may determine the stability level for one or more of the plurality of video frames of the content item (e.g., in the video content of the content item). The stability level may be determined based on the content item. For example, the stability level may indicate an amount of change or motion that is occurring within a particular video frame based on comparing that particular video frame to an immediately preceding and/or immediately following video frame. For example, the stability level may be a relative score based on the number of changes determined or may be a word or phrase (e.g., stable, not stable, minor motion, major motion, etc.) indicating a stability of the first video frame based on the number of changes.

For example, the video evaluation system 106 may determine a first video frame of the plurality of video frames of the content item and a second video frame of the plurality of video frames that immediately precedes the first video frame in the video content. The video evaluation system 106 may determine a quantity of changes that occur within the particular video frame as it goes from the second video frame to the first video frame. For example, the video evaluation system 106 may determine the number of pixel changes that occur when transitioning from the second video frame to the first video frame. For example, a pixel change may be represented by a change in color or shade of the pixel at a particular location within the video frame when transitioning from the second video frame to the first video frame. For another example, an amount of changes based on motion from video frame to adjacent video frame may also be determined and used as a factor in evaluating a stability level for a video frame or group of video frames. Based on the quantity of changes, a stability level for the first video frame may be determined. For example, video frames with relatively less or zero quantity of changes from the preceding and/or following video frame may have the higher or highest stability level relative to other video frames of the plurality of video frames and may be considered to not have any motion occurring in the first video frame. As the quantity of changes increases, the stability level for the first video frame may be less. A stability level may then be determined for one or more other video frames of the plurality of video frames in the video content of the content item.

For example, the stability level for the one or more of the plurality of video frames may be determined in another manner. For example, the stability level of the video frame may be determined by estimating the pixel level motion and checking the motion consistency among the pixels. For example, inconsistent motion among the pixels may indicate an unstable video frame. As such, a stability level may be determined for the one or more of the plurality of video frames based on the motion consistency of the pixels, with consistent motion having a higher stability level and inconsistent motion having a lower stability level.

For example, the video evaluation system 106 may determine a first video frame of the plurality of video frames of the content item and a second video frame of the plurality of video frames that immediately follows the first video frame in the content item (e.g., in the video content of the content item). The video evaluation system 106 may determine a quantity of changes that occur within the particular video frame of the one or more video frames as it goes from the first video frame to the second video frame. For example, the video evaluation system 106 may determine the number of pixel changes that occur when transitioning from the first video frame to the second video frame. Based on the quantity of changes, a stability level for the first video frame may be determined. A stability level may then be determined for each additional video frame of the one or more of the plurality of video frames of the content item.

For example, the video evaluation system 106 may determine a first video frame of the plurality of video frames of the content item, a second video frame of the plurality of video frames that immediately precedes the first video frame in the content item, and a third video frame of the plurality of video frames that immediately follows the first video frame in the content item. The video evaluation system 106 may determine a quantity of changes that occur within the particular video frame as it goes from the second video frame to the first video frame and the quantity of changes that occur within the particular video frame as it goes from the first video frame to the third video frame. For example, the video evaluation system 106 may determine the number of pixel changes that occur when transitioning from the second video frame to the first video frame and from the first video frame to the third video frame. Based on the summed quantity of changes, a stability level for the first video frame may be determined. A stability level may then be determined for each additional video frame of the one or more of the plurality of video frames in the video content of the content item.

For example, rather than determining a stability level, the video evaluation system 106 may determine the sharpness (e.g., sharpness level) of the one or more of the plurality of video frames in the video content of the content item. For example, the video evaluation system 106 may determine the sharpness of the one or more of the plurality of video frames using one or more of edge detection, frequency analysis, and/or local contrast measurements.

At 506, one or more frames, or a portion of the plurality of video frames, may be determined and/or selected for use in generating a description or summary of the content item. The determination or selection of the one or more video frames or the portion of the plurality of video frames may be made by the video evaluation system 106 or another portion of the computing device 104. For example, the one or more video frames or the portion of the plurality of video frames determined or selected may be based on the determined stability level for the one or more of the plurality of video frames of the content item relative to other video frames of the plurality of video frames in the content item (e.g., in the respective scene of the content item). For example, the one or more video frames or the portion of the plurality of video frames determined or selected may be based on the determined sharpness level of the one or more of the plurality of video frames of the content item relative to the sharpness level for other video frames of the plurality of video frames in the content item (e.g., in the respective scene of the content item). For example, a single video frame may be determined or selected for each or one or more of the plurality of scenes or shot angles in the content item (e.g., the video content of the content item). For example, one or more video frames may be determined or selected for each or one or more of the plurality of scenes or shot angles in the content item. The number of video frames selected from the one or more scenes or shot angles may be based on the length of the particular scene or shot angle or the percentage of the content item (e.g., video content of the content item) that the scene or shot angle occurs in.

For example, the video evaluation system 106 may determine and/or select a single video frame from each or one or more scenes or shot angles that has the a higher (e.g., highest) stability level in that particular scene or shot angle relative to other video frames of the plurality of video frames in the content item (e.g., in the respective scene of the content item). For example, the video evaluation system 106 may determine and/or select a single video frame from each or one or more scenes or shot angles that has a higher (e.g., the highest) determined sharpness level in that particular scene or shot angle relative to the determined sharpness level other video frames of the plurality of video frames in the content item (e.g., in the respective scene of the content item). For example, the video evaluation system 106 may determine and/or select a single video frame from each or one or more scenes or shot angles that has a determined stability level that indicates there is no or lower motion occurring in the particular video frame, with respect to its immediately preceding and/or following video frame, relative to the determined stability level for other video frames of the plurality of video frames in the content item (e.g., in the respective scene of the content item). For example, each of the determined and/or selected video frames shall comprise the one or more video frames or the portion of the plurality of video frames from which a description or summary of the content item shall be determined.

At 508, a description or summary of the content in the content item may be generated. The description or summary may be generated by the video evaluation system 106 or another portion of the computing device 104, such as the machine-learning system 110. The description or summary of the content in the content item may be generated based on the video frame, one or more video frames, or the portion of the plurality of video frames of the video content determined or selected. For example, the computing device 104 may generate the description or summary of the content in the content item based on the machine-learning prediction model 134, 230 as described in FIGS. 1-4. For example, this initial description or summary of the content in the content item may be determined and generated based only on the one or more video frames or the portion of the plurality of video frames of the content item determined and selected at 506 and through the use of the machine-learning prediction model 134, 230, and not based on the audio content of the content item, or any additional evaluation of the video content for the content item. For example, the generated description or summary may be a text-based description of the content in the content item based on the scene or view provided by the one or more video frames or the portion of the plurality of video frames of the video content and based on the organization or order of the portion of the video frames of the content item as set forth in the order the content item is output for consumption.

The computing device 104, such as the demographics analyzer 119 or another portion, may evaluate the initial description or summary of the content in the content item and determine one or more user demographics to associate with the initial description or summary. For example, if the content item is an advertisement for medication for post-menopausal women, then at least the demographics of sex (e.g., female) and age (over 45 years of age) may be associated with the content item. When a request is later received from a computing device (e.g., a user device) associated with a user, an identifier of the user device (e.g., device ID, MAC address) and/or the user (e.g., user name, user number, user ID) associated with the user device may be determined. Based on the identifier of the user device and/or the user, one or more demographics of the user associated with the user device may be determined. For example, the one or more demographics may be stored in a database of user data and associated with the particular user. For example, the one or more demographics of the user may be provided by the user via the computing device 160 or may be determined using other methods, such as based on history of content items viewed by user, purchase history, or demographic information associated with the user location. The computing device 104 may determine that one or more of the one or more demographics of the user may match one or more of the user demographics associated with the content item. Based on the match of one or more of the user demographics, the computing device 104 (or another computing device) may send or otherwise cause transmission of the content item to the user device associated with the user and cause the content item to be displayed on the user device associated with the user.

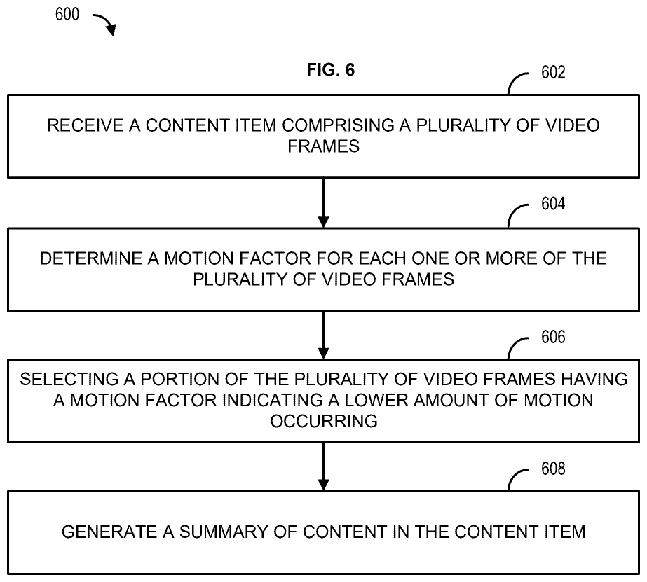

FIG. 6 shows a flowchart of an example method 600 for creating or generating a description or summary of a content item based on a plurality of video frames of a content item. The methods described in FIG. 6 may be completed by a computing device, such as the computing device 104, and/or the machine-learning system 110, or any other computing device described herein. While the method 600 of FIG. 6 will be described as being completed by the computing device 104, this is for example purposes only.

At 602, a content item may be received. For example, the content item may be received by the computing device 104 from one of the content sources 102. For example, the content item may be one or more of an advertisement, an offer for goods or services, a sporting event highlight or review, a news event highlight or review, a preview for or an actual movie, or a preview for or an actual television show. For example, the computing device 104 may receive the content item from one of the content sources via a network device, such as network device 140. For example, the content item may be received from the database 120, which previously received the content item from one of the content sources 102. For example, all or a portion of the content item may be received by the video evaluation system 106 of the computing device 104. For example, the content item may comprise video content and audio content. For example, the content item (e.g., the video content) may comprise a plurality of video frames.

For example, the video evaluation system 106 may receive the plurality of video frames of the content item. The scene detection module 108 of the video evaluation system 106, another portion of the computing device 104, or another computing device may determine one or more scenes or shot angles in the video content of the content item. For example, the scene detection module 108 may determine that the plurality of video frames (e.g., in the video content) of the content item comprises a plurality of scenes or shot angles. The scene detection module 108 may determine the beginning and ending point of each scene or shot angle in the video content. The scene detection module 108 may record or store the beginning and ending point of each scene or shot angle identified. For example, the scene detection module 108 may identify and record the video frame number and/or runtime clock value of the beginning video frame and ending video frame of each scene or shot angle.

At 604, the video evaluation system 106 or another portion of the computing device 104 may determine a motion factor for one or more of the plurality of video frames of the content item (e.g., the video content of the content item). The motion factor may be determined based on the one or more of the plurality of video frames of the content item. For example, the motion factor may indicate an amount of motion that is occurring within a particular video frame based on comparing that particular video frame to an immediately preceding and/or immediately following video frame. For example, the motion factor may be a relative score based on the amount of motion (e.g., number of pixel changes) determined or may be a word or phrase (e.g., motion, no motion, minor motion, major motion, etc.) indicating the amount of motion occurring in objects shown in the first video frame based on the number of changes.

For example, the video evaluation system 106 may determine a first video frame of the plurality of video frames of the video content and a second video frame of the plurality of video frames that immediately precedes the first video frame in the video content. The video evaluation system 106 may determine an amount of motion (e.g., a quantity of changes) that occur to items within the particular video frame as it goes from the second video frame to the first video frame. For example, the video evaluation system 106 may determine the number of pixel changes that occur when transitioning from the second video frame to the first video frame. Based on the amount of motion (e.g., quantity of changes, such as quantity of pixel changes) a motion factor for the first video frame may be determined. For example, video frames with relatively less or zero motion (e.g., no or a zero quantity of changes) from the preceding and/or following video frame (e.g., the second video frame to the first video frame) may have a motion factor indicating less or zero motion (e.g., a lowest motion factor). As the amount of motion increases (e.g., the quantity of changes increases), the motion factor for the first video frame may increase. A motion factor may then be determined for the one or more of the plurality of video frames in the video content of the content item. For example, the system 106 may strive to identify the one or more of the plurality of video frames with zero pixel changes (or motion) or the lowest amount of pixel changes (or motion) or an amount of pixel changes (or motion) that satisfies a pixel change (or motion) threshold (e.g., for each scene or shot angle of the content item) for subsequent use.

For example, the video evaluation system 106 may determine a first video frame of the plurality of video frames of the video content and a second video frame of the plurality of video frames that immediately follows the first video frame in the video content. The video evaluation system 106 may determine an amount of motion (e.g., a quantity of changes) that occurs to items within the particular video frame as it goes from the first video frame to the second video frame. For example, the video evaluation system 106 may determine the number of pixel changes that occur when transitioning from the first video frame to the second video frame. Based on the amount of motion (e.g., quantity of changes, such as quantity of pixel changes) a motion factor for the first video frame may be determined. As the amount of motion increases (e.g., the quantity of pixel changes increases), the motion factor for the first video frame may increase. A motion factor may then be determined for the one or more of the plurality of video frames in the video content of the content item.

For example, the video evaluation system 106 may determine a first video frame of the plurality of video frames of the video content, a second video frame of the plurality of video frames that immediately precedes the first video frame in the video content, and a third video frame of the plurality of video frames that immediately follows the first video frame in the video content. The video evaluation system 106 may determine an amount of motion (e.g., quantity of changes, such as quantity of pixel changes) that occurs to items within the particular video frame as it goes from the second video frame to the first video frame, and the amount of motion (e.g., quantity of changes, such as the quantity of pixel changes) that occurs to items within the particular video frame as it goes from the first video frame to the third. For example, the video evaluation system 106 may determine the number of pixel changes that occur when transitioning from the second video frame to the first video frame and from the first video frame to the third video frame. Based on the summed quantity of pixel changes, a motion factor for the first video frame may be determined. A motion factor may then be determined for each of the one or more of the plurality of video frames in the video content of the content item.

At 606, one or more frames, or a portion of the plurality of video frames, may be determined and/or selected for use in generating a description or summary of the content item. The determination or selection of the one or more video frames or the portion of the plurality of video frames may be made by the video evaluation system 106 or another portion of the computing device 104. For example, the one or more video frames or the portion of the plurality of video frames determined or selected may be based on the motion factor for each video frame of the one or more of the plurality of video frames of the content item. For example, the one or more video frames or the portion of the plurality of video frames determined or selected may be video frames having a motion factor indicating a lower amount (e.g., lowest amount) or no motion occurring in the respective video frame of the one or more video frames of the portion of the plurality of video frames, relative to the motion occurring in the other video frames of the one or more of the plurality of video frames. For example, a single video frame may be determined or selected for each of one or more of the plurality of scenes or shot angles in the content item. For example, one or more video frames may be determined or selected for each of the one or more of the plurality of scenes or shot angles in the video content. The number of video frames taken from each of the one or more of the plurality of scene or shot angle may be based on the length of the particular scene or shot angle or the percentage of the video content that the scene or shot angle occurs in.

For example, the video evaluation system 106 may determine and/or select a single video frame from each of the one or more of the plurality of scenes or shot angles that has the lowest or least amount of motion (e.g., the least amount of change with respect to the immediately prior and/or following video frames) in that particular scene or shot angle, relative to other video frames of the plurality of video frames in that respective scene or shot angle. For example, the video evaluation system 106 may determine and/or select a single video frame from each of the one or more of the plurality of scenes or shot angles that has a motion factor that indicates there is the lowest or no motion occurring in the particular video frame, with respect to its immediately preceding and/or following video frame in the video content, relative to other video frames of the plurality of video frames in that respective scene or shot angle. For example, each of the determined and/or selected video frames shall comprise the one or more video frames or the portion of the plurality of video frames from which a description or summary of the content item shall be determined.

At 608, a description or summary of the content in the content item may be generated. The description or summary may be generated by the video evaluation system 106 or another portion of the computing device 104, such as the machine-learning system 110. The description or summary of the content in the content item may be generated based on the video frame, one or more video frames, or the portion of the plurality of video frames of the video content determined or selected. For example, the computing device 104 may generate the description or summary of the content in the content item based on the machine-learning prediction model 134, 230 as described in FIGS. 1-4. For example, this initial description or summary of the content in the content item may be determined and/or generated based only on the one or more video frames or the portion of the plurality of video frames of the video content determined and selected at 606 and through the use of the machine-learning prediction model 134, 230, and not based on the audio content of the content item or any additional evaluation of the video content for the content item. For example, the generated description or summary may be a text-based description of the content in the content item based on the scene or view provided by the one or more video frames or the portion of the plurality of video frames of the video content and based on the organization or order of the portion of the video frames of the video content as set forth in the order the content item is output for consumption.

The computing device 104, such as the demographics analyzer 119 or another portion, may evaluate the initial description or summary of the content in the content item and determine one or more user demographics to associate with the initial description or summary. For example, if the content item is an advertisement for medication for post-menopausal women, then at least the demographics of sex (e.g., female) and age (over 45 years of age) may be associated with the content item. When a request is later received from a computing device (e.g., a user device) associated with a user, an identifier of the user device (e.g., device ID, MAC address) and/or the user (e.g., user name, user number, user ID) associated with the user device may be determined. Based on the identifier of the user device and/or the user, one or more demographics of the user associated with the user device may be determined. For example, the one or more demographics may be stored in a database of user data and associated with the particular user. For example, the one or more demographics of the user may be provided by the user via the computing device 160 or may be determined using other methods, such as based on history of content items viewed by user, purchase history, or demographic information associated with the user location. The computing device 104 may determine that one or more of the one or more demographics of the user may match one or more of the user demographics associated with the content item. Based on the match of one or more of the user demographics, the computing device 104 (or another computing device) may send or otherwise cause transmission of the content item to the user device associated with the user and cause the content item to be displayed on the user device associated with the user.

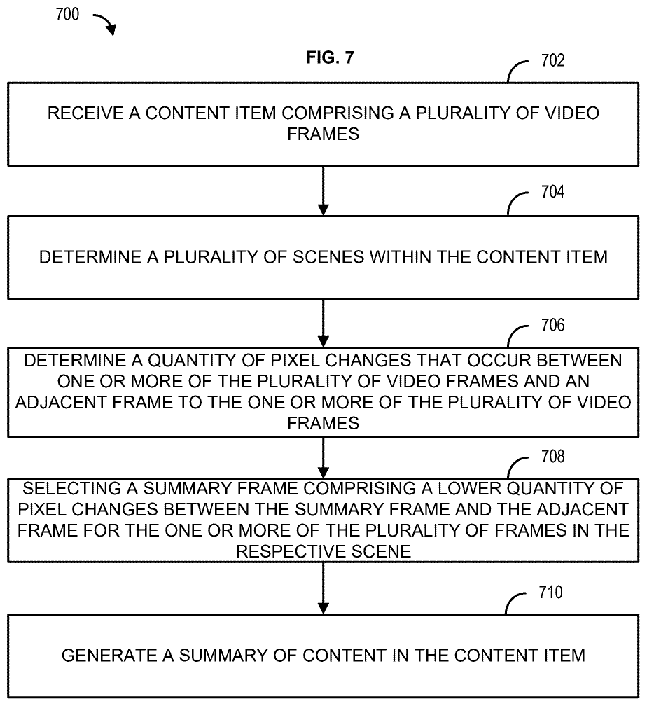

FIG. 7 shows a flowchart of an example method 700 for creating or generating a description or summary of a content item based on one or more of a plurality of video frames of the content item. The methods described in FIG. 7 may be completed by a computing device, such as the computing device 104, and/or the machine-learning system 110, or any other computing device described herein. While the method 700 of FIG. 7 will be described as being completed by the computing device 104, this is for example purposes only.

At 702, a content item may be received. For example, the content item may be received by the computing device 104 from one of the content sources 102. For example, the content item may be one or more of an advertisement, an offer for goods or services, a sporting event highlight or review, a news event highlight or review, a preview for or an actual movie, or a preview for or a television show. For example, the computing device 104 may receive the content item from one of the content sources via a network device, such as network device 140. For example, the content item may be received from the database 120, which previously received the content item from one of the content sources 102. For example, all or a portion of the content item may be received by the video evaluation system 106 of the computing device 104. For example, the content item may comprise video content and audio content. For example, the content item (e.g., the video content) may comprise a plurality of video frames. For example, the video evaluation system 106 may receive the plurality of video frames.

At 704, a plurality of scenes or shot angles may be determined within the content item. For example, the plurality of scenes or shot angles may be determined by the scene detection module 108 of the video evaluation system 106, another portion of the computing device 104, or another computing device. The scene detection module 108 may determine the beginning and ending point of each scene or shot angle in the content item (e.g., in the video content). The scene detection module 108 may record or store the beginning and ending point of each scene or shot angle identified. For example, the scene detection module 108 may identify and record the video frame number and/or runtime clock value of the beginning video frame and ending video frame of each scene or shot angle.

At 706, the video evaluation system 106 or another portion of the computing device 104 may determine a quantity of pixel changes that occur between a video frame and an adjacent video frame for one or more of the plurality of video frames of the content item. The quantity of changes may be determined based on the one or more of the plurality of video frames. For example, the quantity of changes may indicate an amount of change or motion that is occurring within a particular video frame, of the one or more of the plurality of video frames, based on comparing that particular video frame to an immediately preceding and/or immediately following video frame of the plurality of video frames in the content item.

For example, the video evaluation system 106 may determine a first video frame of the plurality of video frames of the content item and a second video frame of the plurality of video frames that immediately precedes the first video frame in the content item. The video evaluation system 106 may determine a quantity of changes (e.g., a quantity of pixel changes) that occur within the particular video frame as it goes from the second video frame to the first video frame. For example, the video evaluation system 106 may determine the number of pixel changes that occur when transitioning from the second video frame to the first video frame. Based on the quantity of changes (e.g., the quantity of pixel changes), a stability level for the first video frame may be determined. For example, video frames with relatively less or zero quantity of changes from the preceding and/or following video frame (e.g., the second video frame to the first video frame) may be considered to have lower or not have any motion occurring in the first video frame, relative to other video frames of the one or more of the plurality of video frames. A quantity of changes may then be determined for one or more additional video frames of the plurality of video frames in the content item. For example, the system 106 may strive to identify the video frame with zero pixel changes (or quantity of changes) or the lowest amount of pixel changes (or quantity of changes) or an amount of pixel changes (or quantity of changes) that satisfies (e.g., is less than or less than or equal to) a pixel change (or quantity of changes) threshold, relative to other video frames of the one or more of the plurality of video frames (e.g., in each of one or more respective scenes or shot changes in the content item) for subsequent use.

For example, the video evaluation system 106 may determine a first video frame of the plurality of video frames of the video content and a second video frame of the plurality of video frames that immediately follows the first frame in the video content. The video evaluation system 106 may determine a quantity of changes that occur within the particular video frame as it goes from the first video frame to the second video frame. For example, the video evaluation system 106 may determine the number of pixel changes that occur when transitioning from the first video frame to the second video frame. A quantity of changes (e.g., pixel changes) may then be determined for one or more additional video frames of the plurality of video frames in the video content of the content item.

For example, the video evaluation system 106 may determine a first video frame of the plurality of video frames of the video content, a second video frame of the plurality of video frames that immediately precedes the first video frame in the video content, and a third video frame of the plurality of video frames that immediately follows the first video frame in the video content. The video evaluation system 106 may determine a quantity of changes (e.g., pixel changes) that occur within the particular video frame as it goes from the second video frame to the first video frame and the quantity of changes (e.g., pixel changes) that occur within the particular video frame as it goes from the first video frame to the third video frame. For example, the video evaluation system 106 may determine the number of pixel changes that occur when transitioning from the second video frame to the first video frame and from the first video frame to the third video frame. The quantity of changes (e.g., pixel changes) from second video frame to first video frame and from first video frame to third video frame may then be summed. A quantity of changes may then be determined for one or more additional video frames of the plurality of video frames in the video content of the content item.

At 708, one or more description or summary video frames may be determined or selected for each of one or more scenes or shot angles of one or a plurality of scenes or shot angles of the content item for use in generating a description or summary of the content item. The determination or selection of the description or summary video frames may be made by the video evaluation system 106 or another portion of the computing device 104. For example, the summary video frame selected from a particular scene or shot angle of the one or plurality of scenes or shot angles in the content item may comprise a zero quantity of changes (e.g., zero pixel changes), the lowest number of changes, or a number of changes that satisfies (e.g., is less than or less than or equal to) a pixel change (or quantity of changes) threshold, between the summary video frame and at least one of the immediately preceding video frame and/or the immediately following video frame, relative to other video frames within that particular scene or shot angle. For example, the summary video frame for each of one or more scenes or shot angles of the one or a plurality of scenes or shot angles of the content item may be determined or selected based on the quantity of changes (e.g., quantity of pixel changes) determined for one or more video frames of the plurality of video frames of the content item. For example, the system 106 may strive to select, as the summary video frame, a video frame with zero pixel changes (or quantity of changes), the lowest amount of pixel changes (or quantity of changes) or an amount of pixel changes (or quantity of changes) that satisfies (e.g., is less than or less than or equal to) a pixel change (or quantity of changes) threshold for each of one or more scenes or shot angles of one or a plurality of scenes or shot angles of the content item, relative to other video frames within the respective scene or shot angle. For example, a single summary video frame may be determined or selected for each of one or more scenes or shot angles of one or a plurality of scenes or shot angles of the content item. For example, one or more summary video frames may be determined or selected for each of one or more scenes or shot angles of one or a plurality of scenes or shot angles of the content item. The number of summary video frames selected from each scene or shot angle may be based on the length of the particular scene or shot angle or the percentage of the video content that the scene or shot angle occurs in.

For example, the video evaluation system 106 may determine and/or select a single summary video frame, from each of one or more scenes or shot angles of one or a plurality of scenes or shot angles of the content item, that has the fewest quantity of changes in that particular scene or shot angle. For example, the video evaluation system 106 may determine and/or select, for each respective scene of the one or more scenes for which summary video frames are to be selected, a single summary video frame from each scene or shot angle that has a zero quantity of changes or the fewest or lowest quantity of changes (e.g., pixel changes) or an amount of changes that satisfies (e.g., is less than or less than or equal to) a quantity of changes threshold, which indicates there is no motion or the least or limited amount of motion occurring in the particular video frame with respect to its immediately preceding and/or following video frame in the video content and relative to the other video frames in that respective scene or shot angle. For example, each of the determined and/or selected summary video frames shall comprise the one or more video frames or the portion of the plurality of video frames from which a description or summary of the content item shall be determined.

At 710, a description or summary of the content in the content item may be generated. The description or summary may be generated by the video evaluation system 106 or another portion of the computing device 104, such as the machine-learning system 110. The description or summary of the content in the content item may be generated based on the summary video frame or a plurality of summary video frames of the video content determined or selected. For example, the computing device 104 may generate the description or summary of the content in the content item based on the machine-learning prediction model 134, 230 as described in FIGS. 1-4. For example, this initial description or summary of the content in the content item may be determined and generated based only on the summary video frame or plurality of summary video frames of the video content determined and selected at 708 and through the use of the machine-learning prediction model 134, 230, and not based on the audio content of the content item, or any additional evaluation of the video content for the content item. For example, the generated description or summary may be a text-based description of the content in the content item based on the scene or view provided by the summary video frame or plurality of summary video frames of the video content and based on the organization or order of the summary video frames of the video content as set forth in the order the content item is output for consumption.

The computing device 104, such as the demographics analyzer 119 or another portion, may evaluate the initial description or summary of the content in the content item and determine one or more user demographics to associate with the initial description or summary. For example, if the content item is an advertisement for medication for post-menopausal women, then at least the demographics of sex (e.g., female) and age (over 45 years of age) may be associated with the content item. When a request is later received from a computing device (e.g., a user device) associated with a user, an identifier of the user device (e.g., device ID, MAC address) and/or the user (e.g., user name, user number, user ID) associated with the user device may be determined. Based on the identifier of the user device and/or the user, one or more demographics of the user associated with the user device may be determined. For example, the one or more demographics may be stored in a database of user data and associated with the particular user. For example, the one or more demographics of the user may be provided by the user via the computing device 160 or may be determined using other methods, such as based on history of content items viewed by user, purchase history, or demographic information associated with the user location. The computing device 104 may determine that one or more of the one or more demographics of the user may match one or more of the user demographics associated with the content item. Based on the match of one or more of the user demographics, the computing device 104 (or another computing device) may send or otherwise cause transmission of the content item to the user device associated with the user and cause the content item to be displayed on the user device associated with the user.

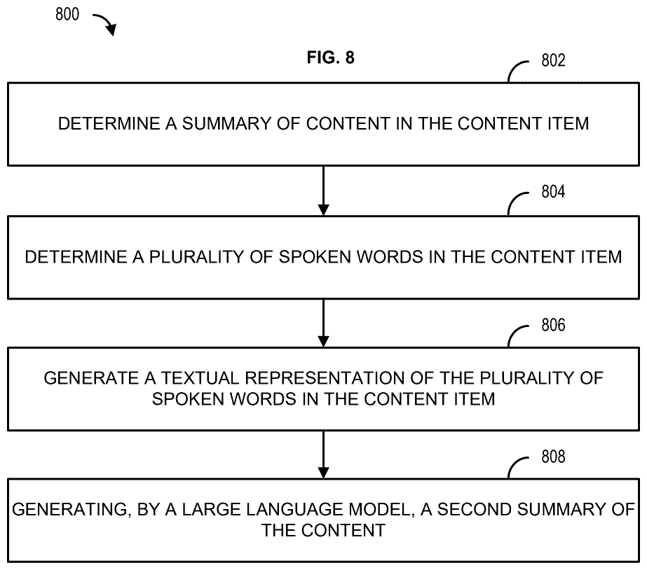

FIG. 8 shows a flowchart of an example method 800 for creating or generating a description or summary of a content item using a large language model, such as the large language model 152. The methods described in FIG. 8 may be completed by a computing device, such as the computing device 104, the machine-learning system 110, and/or the large language model engine 150, or any other computing device described herein. While the method 800 of FIG. 8 will be described as being completed by the computing device 104, this is for example purposes only.

A content item may be received. For example, the content item may be received by the computing device 104 from one of the content sources 102. For example, the content item may be one or more of an advertisement, an offer for goods or services, a sporting event highlight or review, a news event highlight or review, or a preview for a movie or television show. For example, the computing device 104 may receive the content item from one of the content sources via a network device, such as network device 140. For example, the content item may be received from the database 120, which previously received the content item from one of the content sources 102. For example, the content item may comprise video content and audio content. The video content may comprise a plurality of video frames of video content. For example, the video evaluation system 106 may receive the video content of the content item.

At 802, an initial description or summary of content in the content item may be determined. For example, the initial (or first) description or summary may be determined by the computing device 104 or another computing device. For example, the initial description or summary may be determined based on a portion of the video frames of the plurality of video frames in the video content. For example, the initial description or summary of the content may be determined or generated based on any one of the methods described in FIGS. 5-7 above. For example, the initial description or summary may be a text-based description of the content in the content item based on the scene or view provided by the portion of the video frames of the video content and based on the organization or order of the portion of the video frames of the video content as set forth in the order the content item is output for consumption.

At 804, a plurality of spoken words in the content item may be determined. For example, the plurality of the spoken words may be determined by the computing device 104 (e.g., the speech-to-text system 112 or the text analysis engine 114) or another computing device. For example, the content item may comprise video content and audio content. The speech-to-text system 112 may evaluate the audio content of the content item to determine all or a portion of the spoken words within all or a portion of the entirety of the audio content.

For example, the content item may further comprise text data associated with the video content and audio content. For example, the text data may comprise closed-captioning data or another form of text data indicating the spoken words in the audio content of the content item. For example, the text analysis engine 114 may evaluate the text data to determine all or a portion of the spoken words in all or a portion of the audio content of the content item

At 806, a textual representation of the plurality of spoken words in the audio content of the content item may be determined or generated. For example, the textual representation may be determined or generated by the speech-to-text system 112, the text analysis engine 114 or another portion of the computing device 104.

At 808, a second description or summary of the content in the content item may be generated or caused to be generated. For example, the second description or summary may be generated by the large language model engine 150 using the large language model 152. The second description or summary may be generated or caused to be generated based on the initial description or summary of the content in the content item (as discussed in any one of FIGS. 5-7) and the textual representation of the spoken words in the audio content (or text data) of the content item. For example, the computing device 104 may send the initial description or summary of the content in the content item and the textual representation of the spoken words in the audio content (or text data) to the large language model engine 150 via the network 140 or another network. The large language model engine 150, using the large language model 152, may, based on receiving the initial description or summary of the content in the content item and the textual representation of the spoken words in the audio content (or text data), be caused to generate the second description or summary of the content of the content item. The large language model engine 150 may send the second description or summary of the content of the content item to the computing device 104 via the network 140 or another network. For example, the second description or summary of the content may be stored in the content item description or summary 132 of the database 140. While the example of FIGS. 1 and 8 describes the large language model engine 150 as being separate from the computing device 104 and the transmission of data to and from the large language model engine 150 via the network 140, this is for example purposes only. In other examples the large language model engine 150 may be part of the computing device 104 and any sending of data may be an internal operation of the computing device 104.

For example, the computing device 104, such as the audio analyzer 118, may further evaluate the non-verbal audio (e.g., any music, background noise, and/or sound effects) included in the audio content of the content item. The audio analyzer 118 may determine and/or generate a textual representation (e.g., a text description) of the non-verbal audio (e.g., spooky music, loud explosion, ticking clock) in the audio content of the content item. For example, the second description or summary may further be generated or caused to be generated based on the initial description or summary of the content in the content item (as discussed in any one of FIGS. 5-7), the textual representation of the spoken words in the audio content (or text data) of the content item, and the textual representation of the non-verbal audio in the audio content for the content item. For example, the computing device 104 may send the initial description or summary of the content in the content item, the textual representation of the spoken words in the audio content (or text data), and the textual representation of the non-verbal audio in the audio content to the large language model engine 150 via the network 140 or another network. The large language model engine 150, using the large language model 152, may, based on receiving the initial description or summary of the content in the content item, the textual representation of the spoken words in the audio content (or text data), and the textual representation of the non-verbal audio in the audio content of the content item, be caused to generate the second description or summary of the content of the content item. The large language model engine 150 may send the second description or summary of the content of the content item to the computing device 104 via the network 140 or another network.

The computing device 104, such as the demographics analyzer 119 or another portion, may evaluate the second description or summary of the content in the content item and determine one or more user demographics to associate with the second description or summary. For example, if the content item is an advertisement for medication for post-menopausal women, then at least the demographics of sex (e.g., female) and age (over 45 years of age) may be associated with the content item. When a request is later received from a computing device (e.g., a user device) associated with a user, an identifier of the user device (e.g., device ID, MAC address) and/or the user (e.g., user name, user number, user ID) associated with the user device may be determined. Based on the identifier of the user device and/or the user, one or more demographics of the user associated with the user device may be determined. For example, the one or more demographics may be stored in a database of user data and associated with the particular user. For example, the one or more demographics of the user may be provided by the user via the computing device 160 or may be determined using other methods, such as based on history of content items viewed by user, purchase history, or demographic information associated with the user location. The computing device 104 may determine that one or more of the one or more demographics of the user may match or be associated with one or more of the user demographics associated with the content item. Based on the match or association of one or more of the user demographics, the computing device 104 (or another computing device) may send or otherwise cause transmission of the content item to the user device associated with the user and cause the content item to be displayed on the user device associated with the user in response to the request by the user device for or as part of providing the second content item to the user device.

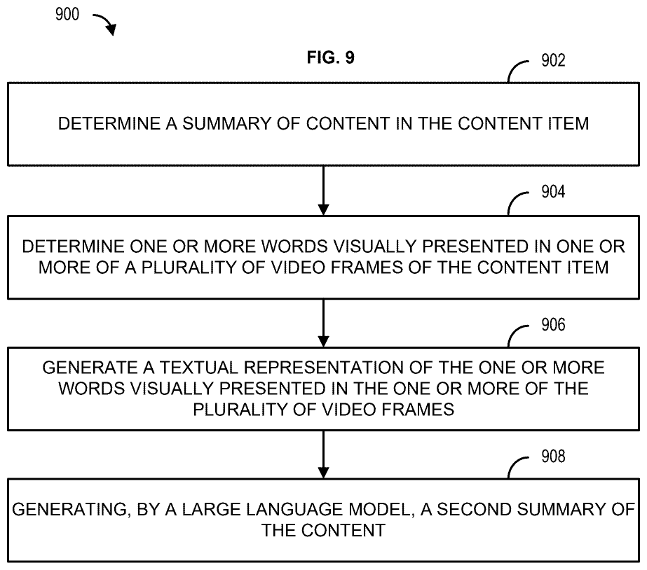

FIG. 9 shows a flowchart of an example method 900 for creating or generating a description or summary of a content item using a large language model, such as the large language model 152. The methods described in FIG. 9 may be completed by a computing device, such as the computing device 104, the machine-learning system 110, and/or the large language model engine 150, or any other computing device described herein. While the method 900 of FIG. 9 will be described as being completed by the computing device 104, this is for example purposes only.

A content item may be received. For example, the content item may be received by the computing device 104 from one of the content sources 102. For example, the content item may be one or more of an advertisement, an offer for goods or services, a sporting event highlight or review, a news event highlight or review, or a preview for a movie or television show. For example, the computing device 104 may receive the content item from one of the content sources via a network device, such as network device 140. For example, the content item may be received from the database 120, which previously received the content item from one of the content sources 102. For example, the content item may comprise video content and audio content. The video content may comprise a plurality of video frames of video content. For example, the video evaluation system 106 may receive the video content of the content item.

At 902, an initial description or summary of content in the content item may be determined. For example, the initial (or first) description or summary may be determined by the computing device 104 or another computing device. For example, the initial description or summary may be determined based on a portion of the video frames of the plurality of video frames in the video content. For example, the initial description or summary of the content may be determined or generated based on any one of the methods described in FIGS. 5-7 above. For example, the initial description or summary may be a text-based description of the content in the content item based on the scene or view provided by the portion of the video frames of the video content and based on the organization or order of the portion of the video frames of the video content as set forth in the order the content item is output for consumption.

At 904, one or more words visually presented in one or more of a plurality of video frames in the content item may be determined. For example, the one or more words visually presented in the one or more of the plurality of video frames in the content item may be determined by the image evaluation system 116 or another portion of the computing device 104. For example, the image evaluation system 116 may evaluate the one or more of the plurality of video frames of the content item using optical character recognition or another form of text identifier to identify and/or determine the one or more words visually presented (e.g., “stop” of a stop sign, a product name, a phone number, etc.) in the one or more of the plurality of video frames. For example, the image evaluation system 116 may evaluate one or more of the plurality of video frames of the content item and determine all or a portion of the words visually presented in the one or more of the plurality of video frames of the content item.

At 906, a textual representation of the one or more words visually presented in the one or more of the plurality of video frames of the content item may be generated or determined. The textual representation of the one or more words visually presented in the one or more of the plurality of video frames may be generated and/or determined by the image evaluation system 116 and based on the one or more of the plurality of video frames of the content item. For example, the textual representation of the one or more words visually presented in the one or more of the plurality of video frames may present the text visually presented in the one or more of the plurality of video frames in the order in which the text is generally viewed when watching the content item.

At 908, a second description or summary of the content in the content item may be generated or caused to be generated. For example, the second description or summary may be generated by the large language model engine 150 using the large language model 152. The second description or summary may be generated or caused to be generated based on the initial description or summary of the content in the content item (as discussed in any one of FIGS. 5-7) and the textual representation of the one or more words visually presented in the video content. For example, the computing device 104 may send the initial description or summary of the content in the content item and the textual representation of the one or more words visually presented in the one or more of the plurality of video frames to the large language model engine 150 via the network 140 or another network. The large language model engine 150, using the large language model 152, may, based on receiving the initial description or summary of the content in the content item and the textual representation of the one or more words visually presented in the one or more of the plurality of video frames, be caused to generate the second description or summary of the content of the content item. The large language model engine 150 may send the second description or summary of the content of the content item to the computing device 104 via the network 140 or another network. For example, the second description or summary of the content may be stored in the content item summary 132 of the database 140. While the example of FIGS. 1 and 9 describes the large language model engine 150 as being separate from the computing device 104 and the transmission of data to and from the large language model engine 150 via the network 140, this is for example purposes only. In other examples the large language model engine 150 may be part of the computing device 104 and any sending of data may be an internal operation of the computing device 104.

For example, the computing device 104, such as the audio analyzer 118, may further evaluate the non-verbal audio (e.g., any music, background noise, and/or sound effects) included in the audio content of the content item. The audio analyzer 118 may determine and/or generate a textual representation (e.g., a text description) of the non-verbal audio (e.g., spooky music, loud explosion, ticking clock) in the audio content of the content item. For example, the second description or summary may further be generated or caused to be generated based on the initial description or summary of the content in the content item (as discussed in any one of FIGS. 5-7), the textual representation of the one or more words visually presented in the one or more of the plurality of video frames, and the textual representation of the non-verbal audio in the audio content for the content item. For example, the computing device 104 may send the initial description or summary of the content in the content item, the textual representation of the one or more words visually presented in the one or more of the plurality of video frames, and the textual representation of the non-verbal audio in the audio content to the large language model engine 150 via the network 140 or another network. The large language model engine 150, using the large language model 152, may, based on receiving the initial description or summary of the content in the content item, the textual representation of the one or more words visually presented in the one or more of the plurality of video frames, and the textual representation of the non-verbal audio in the audio content of the content item, be caused to generate the second description or summary of the content of the content item. The large language model engine 150 may send the second description or summary of the content of the content item to the computing device 104 via the network 140 or another network.

The computing device 104, such as the demographics analyzer 119 or another portion, may evaluate the second description or summary of the content in the content item and determine one or more user demographics to associate with the second description or summary. For example, if the content item is an advertisement for medication for post-menopausal women, then at least the demographics of sex (e.g., female) and age (over 45 years of age) may be associated with the content item. When a request is later received from a computing device (e.g., a user device) associated with a user, an identifier of the user device (e.g., device ID, MAC address) and/or the user (e.g., user name, user number, user ID) associated with the user device may be determined. Based on the identifier of the user device and/or the user, one or more demographics of the user associated with the user device may be determined. For example, the one or more demographics may be stored in a database of user data and associated with the particular user. For example, the one or more demographics of the user may be provided by the user via the computing device 160 or may be determined using other methods, such as based on history of content items viewed by user, purchase history, or demographic information associated with the user location. The computing device 104 may determine that one or more of the one or more demographics of the user may match or be associated with one or more of the user demographics associated with the content item. Based on the match or association of one or more of the user demographics, the computing device 104 (or another computing device) may send or otherwise cause transmission of the content item to the user device associated with the user and cause the content item to be displayed on the user device associated with the user in response to the request by the user device for or as part of providing the second content item to the user device.

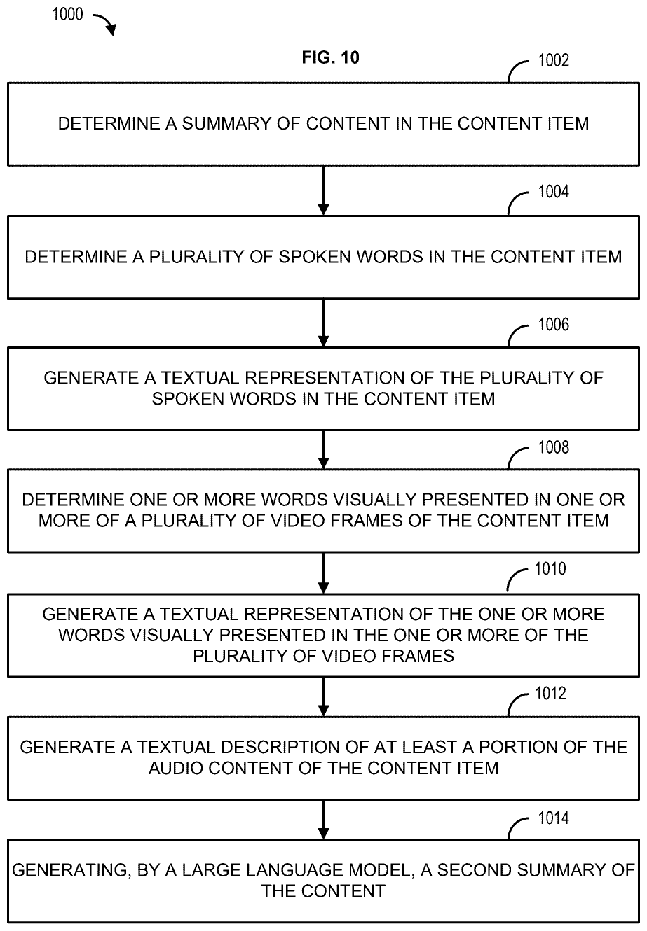

FIG. 10 shows a flowchart of an example method 1000 for creating or generating a description or summary of a content item using a large language model, such as the large language model 152. The methods described in FIG. 10 may be completed by a computing device, such as the computing device 104, the machine-learning system 110, and/or the large language model engine 150, or any other computing device described herein. While the method 1000 of FIG. 10 will be described as being completed by the computing device 104, this is for example purposes only.

A content item may be received. For example, the content item may be received by the computing device 104 from one of the content sources 102. For example, the content item may be one or more of an advertisement, an offer for goods or services, a sporting event highlight or review, a news event highlight or review, or a preview for a movie or television show. For example, the computing device 104 may receive the content item from one of the content sources via a network device, such as network device 140. For example, the content item may be received from the database 120, which previously received the content item from one of the content sources 102. For example, the content item may comprise video content and audio content. The video content may comprise a plurality of video frames of video content. For example, the video evaluation system 106 may receive the video content of the content item.

At 1002, an initial description or summary of content in the content item may be determined. For example, the initial (or first) description or summary may be determined by the computing device 104 or another computing device. For example, the initial description or summary may be determined based on a portion of the video frames of the plurality of video frames in the video content. For example, the initial description or summary of the content may be determined or generated based on any one of the methods described in FIGS. 5-7 above. For example, the initial description or summary may be a text-based description of the content in the content item based on the scene or view provided by the portion of the video frames of the video content and based on the organization or order of the portion of the video frames of the video content as set forth in the order the content item is output for consumption.

At 1004, a plurality of spoken words in the content item may be determined. For example, the plurality of the spoken words may be determined by the computing device 104 (e.g., the speech-to-text system 112 or the text analysis engine 114) or another computing device. For example, the content item may comprise video content and audio content. The speech-to-text system 112 may evaluate the audio content of the content item to determine all or a portion of the spoken words within all or a portion of the entirety of the audio content.

For example, the content item may further comprise text data associated with the video content and audio content. For example, the text data may comprise closed-captioning data or another form of text data indicating the spoken words in the audio content of the content item. For example, the text analysis engine 114 may evaluate the text data to determine all or a portion of the spoken words in all or a portion of the audio content of the content item

At 1006, a textual representation of the plurality of spoken words in the audio content of the content item may be determined or generated. For example, the textual representation may be determined or generated by the speech-to-text system 112, the text analysis engine 114 or another portion of the computing device 104.

At 1008, one or more words visually presented in one or more of a plurality of video frames of the content item may be determined. For example, the one or more words visually presented in the one or more of the plurality of video frames may be determined by image evaluation system 116 or another portion of the computing device 104. For example, the image evaluation system 116 may evaluate the one or more of the plurality of video frames of the content item using optical character recognition or another form of text identifier to identify and/or determine the one or more words visually presented (e.g., “stop” of a stop sign, a product name, a phone number, etc.) in the one or more of the plurality of video frames. For example, the image evaluation system 116 may evaluate all or a portion of the plurality of video frames and determine all or a portion of the words visually presented in the one or more of the plurality of video frames of the content item.

At 1010, a textual representation of the one or more words visually presented in the one or more of the plurality of video frames of the content item may be generated or determined. The textual representation of the one or more words visually presented in the one or more of the plurality of video frames may be generated and/or determined by the image evaluation system 116 and based on the video content of the content item. For example, the textual representation of the one or more words visually presented in the one or more of the plurality of video frames may present the text visually presented in the one or more of the plurality of video frames in the order in which the text is generally viewed when watching the content item.

At 1012, a textual representation of the non-verbal audio in the audio content of the content item may be determined and/or generated. For example, the textual representation of the non-verbal audio of the audio content may be determined by the computing device 104, such as the audio analyzer 118. For example, the audio analyzer 118 may evaluate the non-verbal audio (e.g., any music, background noise, and/or sound effects) included in the audio content of the content item to determine and/or generate a textual representation (e.g., a text description) of the non-verbal audio (e.g., spooky music, loud explosion, ticking clock) in the audio content of the content item.

At 1014, a second description or summary of the content in the content item may be generated or caused to be generated. For example, the second description or summary may be generated by the large language model engine 150 using the large language model 152. The second description or summary may be generated or caused to be generated based on the initial description or summary of the content in the content item (as discussed in any one of FIGS. 5-7), the textual representation of the spoken words in the audio content (or text data) of the content item, the textual representation of the one or more words visually presented in the one or more of the plurality of video frames of the content item, and/or the textual representation of the non-verbal audio in the audio content of the content item. For example, the computing device 104 may send the initial description or summary of the content in the content item, the textual representation of the spoken words in the audio content (or text data) of the content item, the textual representation of the one or more words visually presented in the one or more of the plurality of video frames of the content item, and/or the textual representation of the non-verbal audio in the audio content of the content item to the large language model engine 150 via the network 140 or another network. The large language model engine 150, using the large language model 152, may, based on receiving the initial description or summary of the content in the content item, the textual representation of the spoken words in the audio content (or text data) of the content item, the textual representation of the one or more words visually presented in the one or more of the plurality of video frames of the content item, and/or the textual representation of the non-verbal audio in the audio content of the content item, be caused to generate the second description or summary of the content of the content item. The large language model engine 150 may send the second description or summary of the content of the content item to the computing device 104 via the network 140 or another network. For example, the second description or summary of the content may be stored in the content item description or summary 132 of the database 140. While the example of FIGS. 1 and 8 describes the large language model engine 150 as being separate from the computing device 104 and the transmission of data to and from the large language model engine 150 via the network 140, this is for example purposes only. In other examples the large language model engine 150 may be part of the computing device 104 and any sending of data may be an internal operation of the computing device 104.

The computing device 104, such as the demographics analyzer 119 or another portion, may evaluate the second description or summary of the content in the content item and determine one or more user demographics to associate with the second description or summary. For example, if the content item is an advertisement for medication for post-menopausal women, then at least the demographics of sex (e.g., female) and age (over 45 years of age) may be associated with the content item. When a request is later received from a computing device (e.g., a user device) associated with a user, an identifier of the user device (e.g., device ID, MAC address) and/or the user (e.g., user name, user number, user ID) associated with the user device may be determined. Based on the identifier of the user device and/or the user, one or more demographics of the user associated with the user device may be determined. For example, the one or more demographics may be stored in a database of user data and associated with the particular user. For example, the one or more demographics of the user may be provided by the user via the computing device 160 or may be determined using other methods, such as based on history of content items viewed by user, purchase history, or demographic information associated with the user location. The computing device 104 may determine that one or more of the one or more demographics of the user may match or be associated with one or more of the user demographics associated with the content item. Based on the match or association of one or more of the user demographics, the computing device 104 (or another computing device) may send or otherwise cause transmission of the content item to the user device associated with the user and cause the content item to be displayed on the user device associated with the user in response to the request by the user device for or as part of providing the second content item to the user device.

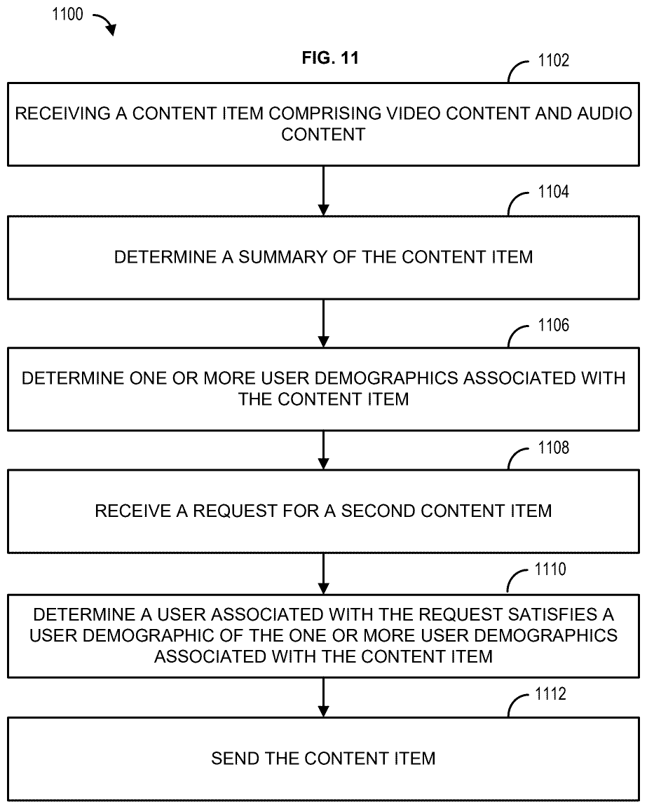

FIG. 11 shows a flowchart of an example method 1100 for determining targeted content items and providing those targeted content items to user devices associated with a user. The methods described in FIG. 11 may be completed by a computing device, such as the computing device 104, the machine-learning system 110, and/or the large language model engine 150, or any other computing device described herein. While the method 1100 of FIG. 11 will be described as being completed by the computing device 104, this is for example purposes only.

A content item may be received. For example, the content item may be received by the computing device 104 from one of the content sources 102. For example, the content item may be one or more of an advertisement, an offer for goods or services, a sporting event highlight or review, a news event highlight or review, or a preview for a movie or television show. For example, the computing device 104 may receive the content item from one of the content sources via a network device, such as network device 140. For example, the content item may be received from the database 120, which previously received the content item from one of the content sources 102. For example, the content item may comprise video content and audio content. The video content may comprise a plurality of video frames of video content. For example, the video evaluation system 106 may receive the video content of the content item.

At 1104 a description or summary of the content item may be determined and/or generated. For example, the description or summary may be determined and or generated (or caused to be generated) by the computing device 104, such as the machine learning system 110, or via the large language model engine 150. For example, the description or summary of the content item may be determined and/or generated as described with regard to determining and/or generating the initial description or summary in FIGS. 5-7 and/or as described with regard to determining and/or generating the second description or summary in FIGS. 8-10 above.

At 1106, one or more user demographics associated with the content item may be determined. For example, the one or more user demographics associated with the content item may be determined by the computing device 104, such as the demographics analyzer 119. For example, the demographics analyzer 119 may evaluate the initial description or summary of the content (as described in FIGS. 5-7) or the second description or summary (as described in FIGS. 8-10) of the content in the content item and determine one or more user demographics to associate with the initial description or summary or second description or summary. For example, if the content item is an advertisement for medication for post-menopausal women, then at least the demographics of sex (e.g., female) and age (over 45 years of age) may be associated with the content item. For example, the demographics analyzer 119 may tag or associate the determined user demographic targets for the content item, such as in the content items 122 of the database 120.

At 1108, a request for a second content item may be received. For example, the request may be received by the computing device 104 or an associated server from a computing device 160 (e.g., a user device associated with a user) via the network 140 or another network. For example, the request for the second content item may be received after the evaluation of the content item as described in FIGS. 5-10. The second content item may comprise video content and/or audio content. For example, the second content item may comprise one of a movie, television show, sporting event; news program, product offering, or advertisement.

At 1110, the user associated with the user device from which the request for the second content item was received may be determined to satisfy one or more of the user demographics associated with the content item of FIGS. 5-10. For example, the determination may be made by the computing device 104. The determination may be made based on receiving the request for the second content item. For example, when the request is received from the computing device 160 (e.g., the user device), an identifier of the user device (e.g., device ID, MAC address) and/or the user (e.g., user name, user number, user ID) associated with the user device may be determined. For example, the identifier of the user device and/or the user may be received as part of the request for the second content item. Based on the identifier of the user device and/or the user, one or more demographics of the user associated with the user device may be determined. For example, the one or more demographics may be stored in a database of user data and associated with the particular user. For example, the one or more demographics of the user may be provided by the user via the computing device 160 or may be determined using other methods, such as based on history of content items viewed by user, purchase history, or demographic information associated with the user location. The computing device 104 may determine that one or more of the one or more demographics of the user may match or be associated with one or more of the user demographics associated with the content item.

At 1112, the second content item may be sent, transmitted, or caused to be sent. For example, the second content item may be sent by the computing device 104 to the computing device 160 (e.g., the user device) via the network 140 or another network. For example, the second content item may be sent to the user device based on the match or association of one or more of the user demographics of the user associated with the user device to the one or more user demographics associated with the content item. The content item may be caused to be displayed on the user device associated with the user in response to the request by the user device for or as part of providing the second content item to the user device.

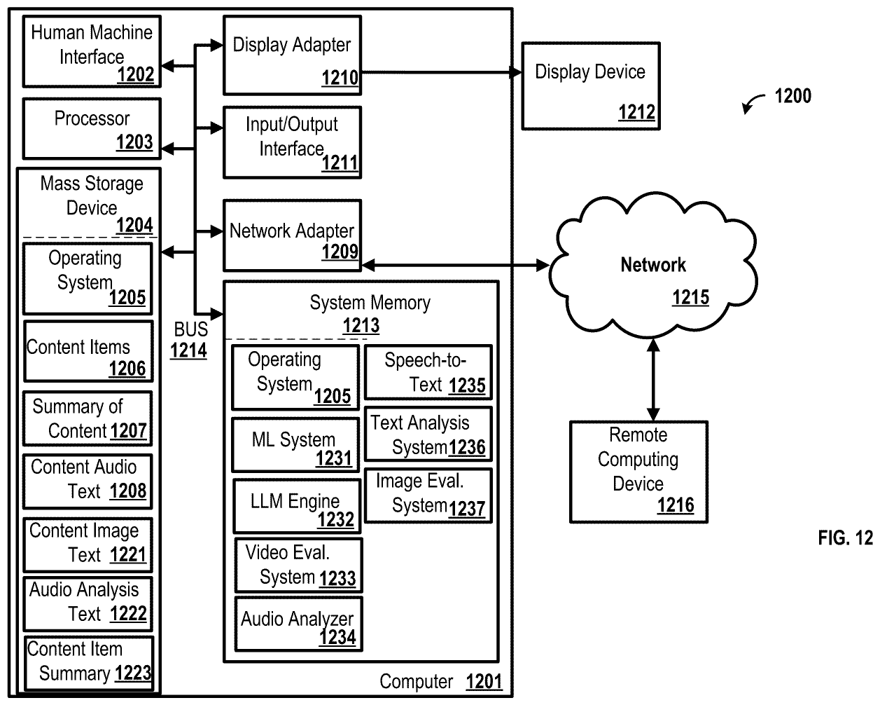

FIG. 12 shows a block diagram of an example system 1200 and computer 1201 for generating summaries of content items. Any device/component described herein (e.g., the computing device 104, the machine-learning system 110, the large language model engine 150, or the computing device 160) may be the computer 1201 as shown in FIG. 12.

The computer 1201 may include one or more processors 1203, a system memory 1213, and a bus 1214 that couples various components of the computer 1201 including the one or more processors 1203 to the system memory 1213. In the case of multiple processors 1203, the computer 1201 may utilize parallel computing.

The bus 1214 may include one or more of several possible types of bus structures, such as a memory bus, memory controller, a peripheral bus, an accelerated graphics port, and a processor or local bus using any of a variety of bus architectures.

The computer 1201 may operate on and/or include a variety of computer-readable media (e.g., non-transitory). Computer-readable media may be any available media that is accessible by the computer 1201 and includes, non-transitory, volatile and/or non-volatile media, removable and non-removable media. The system memory 1213 has computer-readable media in the form of volatile memory, such as random access memory (RAM), and/or non-volatile memory, such as read-only memory (ROM). The system memory 1213 may store program modules such as an operating system 1205, a machine-learning system 1231, a large language model engine 1232, a video evaluation system 1233, an audio analyzer system 1234, a speech-to-text system 1235, a text analysis system 1236, and/or an image evaluation system 1237 that are accessible to and/or are operated on by the one or more processors 1203.

The computer 1201 may also include other removable/non-removable, volatile/non-volatile computer storage media. The mass storage device 1204 may provide non-volatile storage of computer code, computer-readable instructions, data structures, program modules, and other data for the computer 1201. The mass storage device 1204 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1204. An operating system 1205 and any of the modules accessible on the system memory 1213 may be stored on the mass storage device 1204. In addition, content items 1206, initial summaries of content 1207; content audio text 1208, content image text 1221, audio analysis text 1222, and or second summaries of content items 1223 may be stored in the mass storage device 1204. The content items 1206, initial summaries of content 1207; content audio text 1208, content image text 1221, audio analysis text 1222, and or second summaries of content items 1223 may be stored in any of one or more databases known in the art. The databases may be centralized or distributed across multiple locations within the network 1215.

A user may enter commands and information into the computer 1201 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 1203 via a human machine interface 1202 that is coupled to the bus 1214, but may be connected by other interface and bus structures, such as a parallel port, game port, an IEEE 1394 Port (also known as a Firewire port), a serial port, network adapter 1209, and/or a universal serial bus (USB).

A display device 1212 may also be connected to the bus 1214 via an interface, such as a display device adapter 1210. It is contemplated that the computer 1201 may have more than one display device adapter 1210 and the computer 1201 may have more than one display device 1212. A display device 1212 may be a monitor, an LCD (Liquid Crystal Display device), light-emitting diode (LED) display device, television, smart lens, smart glass, and/or a projector. In addition to the display device 1212, other output peripheral devices may comprise components such as speakers (not shown) and a printer (not shown) which may be connected to the computer 1201 via Input/Output Interface 1211. Any step and/or result of the methods may be output (or caused to be output) in any form to an output device. Such output may be any form of visual representation, including, but not limited to, textual, graphical, animation, audio, tactile, and the like. The display device 1212 and computer 1201 may be part of one device or separate devices.

The computer 1201 may operate in a networked environment using logical connections to one or more remote computing devices 1216 (e.g., user devices, such as laptop computers, desktop computers, computing station, tablet devices, mobile computing devices, mobile phone, wearable smart devices, a server, a network computer, a peer device, an edge device, or other common network nodes, etc.). Logical connections between the computer 1201 and the remote computing device 1216 may be made via a network 1215, such as a local area network (LAN) and/or a general wide area network (WAN). Such network connections may be through a network adapter 1209. The network adapter 1209 may be implemented in both wired and wireless environments. Such networking environments are conventional and commonplace in dwellings, offices, enterprise-wide computer networks, intranets, and the Internet.

Application programs and other executable program components such as the operating system 1205, the machine-learning system 1231, the large language model engine 1232, the video evaluation system 1233, the audio analyzer system 1234, the speech-to-text system 1235, the text analysis system 1236, and/or the image evaluation system 1237 are shown herein as discrete blocks, although it is recognized that such programs and components may reside at various times in different storage components of the computing device 1201, and are executed by the one or more processors 1203 of the computer 1201. An implementation of the machine-learning system 1231, the large language model engine 1232, the video evaluation system 1233, the audio analyzer system 1234, the speech-to-text system 1235, the text analysis system 1236, and/or the image evaluation system 1237 may be stored on or sent across some form of computer-readable media. Any of the disclosed methods may be performed by processor-executable instructions embodied on computer-readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, a content item comprising a plurality of video frames;
determining a stability level for one or more of the plurality of video frames;
selecting, based on the determined stability level, a portion of the plurality of video frames, wherein the portion of the plurality of video frames have a higher stability level relative to other video frames of the plurality of video frames; and
generating, based on the portion of the plurality of video frames, a summary of content in the content item.

2. The method of claim 1, wherein selecting the portion of the plurality of video frames comprises:
determining a plurality of scenes in the content item; and
selecting, for each of the plurality of scenes, a video frame, of the plurality of video frames, with a higher stability level relative to other video frames for the respective scene, of the plurality of scenes, for inclusion in the portion of the plurality of video frames.

3. The method of claim 1, wherein determining the stability level for the one or more of the plurality of video frames comprises:
determining a first video frame of the plurality of video frames and a second video frame of the plurality of video frames that immediately precedes the first video frame; and
determining, based on a quantity of changes from the second video frame to the first video frame, the stability level for the first video frame.

4. The method of claim 1, wherein determining the stability level for the one or more of the plurality of video frames comprises:
determining a first video frame of the plurality of video frames and a second video frame of the plurality of video frames that immediately follows the first video frame; and
determining, based on a quantity of changes from the first video frame to the second video frame, the stability level for the first video frame.

5. The method of claim 1, wherein generating the summary of the content in the content item comprises determining, based on the portion of the plurality of video frames and a machine-learning prediction model, the summary of the content.

6. The method of claim 1, further comprising:
determining a plurality of spoken words in the content item;
generating, based on the plurality of spoken words in the content item, a textual representation of the plurality of spoken words;
determining, one or more words presented in the plurality of video frames of the content item; and
generating, by a large language model and based on the summary of content in the content item, the textual representation of the plurality of spoken words, and the one or more words presented in the plurality of video frames of the content item, a second summary of the content.

7. The method of claim 1, wherein the content item comprises one of an advertisement or an offer of goods or services.

8. The method of claim 1, further comprising determining, based on the summary of the content in the content item, at least one user demographic associated with the content item.

9. A method comprising:
receiving, by a computing device, a content item comprising a plurality of video frames;
determining a motion factor for one or more of the plurality of video frames, wherein the motion factor indicates an amount of motion occurring in the respective video frame;
selecting, based on the determined motion factor, a portion of the plurality of video frames having a motion factor indicating a lower amount of motion occurring relative to other vide frames of the plurality of video frames in each respective video frame of the portion of the plurality of video frames; and
generating, based on the portion of the plurality of video frames, a summary of content in the content item.

10. The method of claim 9, wherein selecting the portion of the plurality of video frames comprises:
determining a plurality of scenes in the content item; and
selecting, for each of the plurality of scenes, a video frame, of the plurality of video frames, having a motion factor indicating a least amount of motion occurring in the video frame relative to other video frames in the respective scene, for inclusion in the portion of the plurality of video frames.

11. The method of claim 9, wherein determining the motion factor for the one or more of the plurality of video frames comprises:
determining a first video frame of the plurality of video frames and a second video frame of the plurality of video frames that immediately precedes the first video frame; and
determining, based on a quantity of pixel changes from the second video frame to the first video frame, the motion factor for the first video frame.

12. The method of claim 9, wherein determining the motion factor for the one or more of the plurality of video frames comprises:
determining a first video frame of the plurality of video frames and a second video frame of the plurality of video frames that immediately follows the first video frame; and
determining, based on a quantity of pixel changes from the first video frame to the second video frame, the motion factor for the first video frame.

13. The method of claim 9, wherein generating the summary of the content in the content item comprises determining, based on the portion of the plurality of video frames and a machine-learning prediction model, the summary of the content.

14. The method of claim 9, further comprising:
determining a plurality of spoken words in the content item;
generating, based on the plurality of spoken words in the content item, a textual representation of the plurality of spoken words;
determining, one or more words presented in the plurality of video frames; and
generating, by a large language model and based on the summary of content in the content item, the textual representation of the plurality of spoken words, and the one or more words presented in the plurality of video frames, a second summary of the content.

15. The method of claim 9, wherein the content item comprises one of an advertisement or an offer of goods or services.

16. A method comprising:
receiving, by a computing device, a content item comprising a plurality of video frames;
determining a plurality of scenes within the content item;
determining a quantity of pixel changes that occur between one or more of the plurality of video frames and an adjacent frame to the one or more of the plurality of video frames;
selecting, for one or more scenes of the plurality of scenes, a summary frame comprising a determined lower quantity of pixel changes between the summary frame and the adjacent frame for the one or more of the plurality of frames in the respective scene; and
generating, based on the selected summary frame from the one or more scenes of the plurality of scenes, a summary of content in the content item.

17. The method of claim 16, wherein generating the summary of the content in the content item comprises determining, based on the selected summary frame from each scene of the one or more scenes of the plurality of scenes and a machine-learning prediction model, the summary of the content.

18. The method of claim 16, further comprising:
determining a plurality of spoken words in the content item;
generating, based on the plurality of spoken words in the content item, a textual representation of the plurality of spoken words;
determining, one or more words presented in the plurality of video frames; and
generating, by a large language model and based on the summary of content in the content item, the textual representation of the plurality of spoken words, and the one or more words presented in the plurality of video frames, a second summary of the content.

19. The method of claim 18, further comprising determining, based on the second summary of the content, at least one user demographic associated with the content item.

20. The method of claim 16, wherein the content item comprises one of an advertisement or an offer of goods or services.
